(19) United States
(12) Patent Application Publication
(10) Pub. No.: US 2018/0372832 A1
(43) Pub. Date: Dec. 27, 2018

(54) COMMUNICATION DEVICE AND ELECTRONIC DEVICE HAVING SAME

(71) Applicant: LG ELECTRONICS INC., Seoul (KR)

(72) Inventors: Kyoungsuk KO, Seoul (KR); Byungjin KIM, Seoul (KR); Jeonghwan YOON, Seoul (KR); Koh CHOI, Seoul (KR); Myunghwan HA, Seoul (KR); Sunghyuk PARK, Seoul (KR)

(73) Assignee: LG ELECTRONICS INC., Seoul (KR)

(21) Appl. No.: 16/063,222

(22) PCT Filed: Dec. 16, 2016
(86) PCT No.: PCT/KR2016/014800

§ 371 Date: Jun. 15, 2018

(30) Foreign Application Priority Data
Dec. 18, 2015 (KR) 10-2015-0181740

(51) Int. Cl. G01S 3/48; G01S 5/10; G01S 5/02

(52) U.S. Cl. CPC G01S 3/48; H04B 7/0686; G01S 5/0221; G01S 5/10

(57) ABSTRACT

The present invention relates to a communication device and an electronic device having the same. A communication device according to an embodiment of the present invention comprises: first to third antennas arranged to be spaced different distances from each other; first to third transceiving units; and a processor for controlling the first to third transceiving units, wherein the processor calculates a first phase difference on the basis of a difference between a first reception signal received by the first antenna and a second reception signal received by the second antenna, calculates a second phase difference on the basis of a difference between the first reception signal received by the first antenna and a third reception signal received by the third antenna, and calculates location information of an external communication device on the basis of the first phase difference and the second phase difference. Therefore, the present invention can accurately calculate the location information of the external communication device.

### TECHNICAL FIELD

The present invention relates to a communication device and an electronic device including the same, for accurately calculating position information of an external communication device.

### BACKGROUND ART

A communication device is capable of performing data communication with an external communication device.

To recognize a position of the external communication device, the communication device may use a positioning method.

An example of a well-known positioning method includes a method using a time difference of arrival (TDoA) based on a time of arrival and a trigonometric equation, a time of arrival (TOA) obtained by calculating time taken for a radio wave to arrive, an angle of arrival (AoA) using a transmitted signal angle, and received signal strength indication (RSSI), and a Wi-Fi positioning scheme using a radio AP.

Various attempts have been made to improve accuracy of positioning.

### DISCLOSURE

### Technical Problem

Therefore, the present invention has been made in view of the above problems, and it is an object of the present invention to provide a communication device and an electronic device including the same, for accurately calculating position information on an external communication device.

### Technical Solution

In accordance with the present invention, the above and other objects can be accomplished by the provision of a communication device including first to third antennas spaced apart from each other by different distances, first to third transceivers connected to the first to third antennas and to output transmit signals to the first to third antennas, respectively, or to receive received signals from the first to third antennas, respectively, and a processor to control the first to third transceivers, wherein the processor calculates a first phase difference based on a difference between a first received signal received by the first antenna and a second received signal received by the second antenna, calculates a second phase difference based on a difference between the first received signal received by the first antenna and a third received signal received by the third antenna, and calculates position information of an external communication device based on the first phase difference and the second phase difference.

In accordance with another aspect of the present invention, there is provided a communication device including first to third antennas spaced apart from each other by different distances, a first transceiver connected to the first antenna, a switch connected to second and third antennas and to perform a switching operation, a second transceiver connected to the switch, and a processor to control the first to second transceivers and the switch, wherein, in a state in which the second antenna is switched on by the switch, the processor calculates a first phase difference based on a difference between a first received signal received by the first antenna and a second received signal received by the second antenna and controls the first antenna to output a transmit signal based on the first received signal and, in a state in which the third antenna is switched on by the switch, the processor calculates a first phase difference based on a third received signal received by the first antenna and a fourth received signal received by the third antenna and calculates position information of an external communication device based on the first phase difference and the second phase difference, in response to the transmit signal.

In accordance with another aspect of the present invention, there is provided a communication device including first and second antennas spaced apart from each other, first and second transceivers connected to the first and second antennas and to output transmit signals to the first and second antennas, respectively, or to receive received signals from the first and second antennas, respectively, and a processor to control the first and second transceivers, wherein the processor calculates a first phase difference based on a difference between a first-frequency first received signal received by the first antenna and a first-frequency second received signal received by the second antenna, calculates a second phase difference based on a difference between a second-frequency third received signal received by the first antenna and a second-frequency fourth received signal received by the second antenna, and calculates position information of an external communication device based on the first phase difference and the second phase difference.

In accordance with a further aspect of the present invention, there is provided an electronic device including a communication device including first to third antennas spaced apart from each other by different distances, first to third transceivers connected to the first to third antennas and to output transmit signals to the first to third antennas, respectively, or to receive received signals from the first to third antennas, respectively, and a processor to control the first to third transceivers, wherein the processor calculates a first phase difference based on a difference between a first received signal received by the first antenna and a second received signal received by the second antenna, calculates a second phase difference based on a difference between the first received signal received by the first antenna and a third received signal received by the third antenna, and calculates position information of an external communication device based on the first phase difference and the second phase difference, and a processor to maintain to be connected to the external communication device, the position information of which is calculated.

### Advantageous Effects

According to an embodiment of the present disclosure, a communication device and an electronic device including the same includes first to third antennas spaced apart from each other by different distances, first to third transceivers connected to the first to third antennas and to output transmit signals to the first to third antennas, respectively, or to receive received signals from the first to third antennas, respectively, and a processor to control the first to third transceivers, wherein the processor calculates a first phase difference based on a difference between a first received signal received by the first antenna and a second received signal received by the second antenna, calculates a second phase difference based on a difference between the first received signal received by the first antenna and a third received signal received by the third antenna, and calculates position information of an external communication device based on the first phase difference and the second phase difference to accurately calculate the position information of the external communication device. In particularly, it may be possible to calculate accurate position information robust noise.

The processor may calculate angle information of the position information of the external communication device based on the first phase difference and the second phase difference. As such, in an angle of arrival (AoA) method using a transmitted signal angle, angle information of the external communication device may be accurately calculated.

The processor may control the first antenna to output a transmit signal based on a first received signal and may calculate distance information of the external communication device based on a time difference between a fourth received signal received by the first antenna and a transmit signal in response to the transmit signal and, thus, may acquire the distance information of the external communication device.

The processor may perform signal processing on a received signal with a highest level among a plurality of received signals received by the first antenna and, thus, may access a pointed external communication device among a plurality of external devices.

According to another embodiment of the present invention, a communication device and an electronic device including the same may include first to third antennas spaced apart from each other by different distances, a first transceiver connected to the first antenna, a switch connected to second and third antennas and to perform a switching operation, a second transceiver connected to the switch, and a processor to control the first to second transceivers and the switch, wherein, in a state in which the second antenna is switched on by the switch, the processor calculates a first phase difference based on a difference between a first received signal received by the first antenna and a second received signal received by the second antenna and controls the first antenna to output a transmit signal based on the first received signal and, in a state in which the third antenna is switched on by the switch, the processor calculates a first phase difference based on a third received signal received by the first antenna and a fourth received signal received by the third antenna and calculates position information of an external communication device based on the first phase difference and the second phase difference, in response to the transmit signal, to accurately calculate the position information of the external communication device.

According to another embodiment of the present invention, a communication device and an electronic device including the same includes first and second antennas spaced apart from each other, first and second transceivers connected to the first and second antennas and to output transmit signals to the first and second antennas, respectively, or to receive received signals from the first and second antennas, respectively, and a processor to control the first and second transceivers, wherein the processor calculates a first phase difference based on a difference between a first-frequency first received signal received by the first antenna and a first-frequency second received signal received by the second antenna, calculates a second phase difference based on a difference between a second-frequency third received signal received by the first antenna and a second-frequency fourth received signal received by the second antenna, and calculates position information of an external communication device based on the first phase difference and the second phase difference, to accurately calculate the position information of the external communication device.

### DESCRIPTION OF DRAWINGS

FIG. 1 is a diagram showing a concept of communication of a communication device according to an embodiment of the present invention.

FIG. 2 is an internal block diagram of an example of the communication device of FIG. 1.

FIGS. 3A to 3D show various examples of an electronic device including the communication device of FIG. 1 or 2.

FIG. 4 is a diagram showing a device remote control system using a remote control device of FIG. 3A.

FIGS. 5A to 5F are diagrams showing an example of the case in which a type of a controlled device is changed according to a pointed direction of the remote control device of FIG. 4.

FIG. 6 is an internal block diagram of the remote control device of FIG. 4.

FIGS. 7A to 9D are diagrams for explanation of a communication device.

FIG. 10 is a diagram showing an example of an operation method of a communication device according to an embodiment of the present invention.

FIG. 11 is an internal block diagram of an example of a communication device according to an embodiment of the present invention.

FIG. 12 is a diagram for explanation of an operation of the communication device of FIG. 11.

FIGS. 13A to 13C are internal block diagrams of an example of a communication device according to another embodiment of the present invention.

FIGS. 14A and 14B are diagrams for explanation of an operation of the communication device of FIGS. 13A to 13C.

FIG. 15 is an internal block diagram of an example of a communication device according to another embodiment of the present invention.

FIG. 16 is a flowchart for explanation of an operation of the communication device of FIG. 15.

FIGS. 17 and 18 are diagrams for explanation of an operation of the communication device of FIG. 15 or 16.

FIGS. 19 to 20B are diagrams for explanation of an operation of a communication device according to the present invention.

### BEST MODE

Reference will now be made in detail to the preferred embodiments of the present invention, examples of which are illustrated in the accompanying drawings.

Hereinafter, the suffixes “module” and “unit” of elements herein are used for convenience of description and do not have any distinguishable meanings or functions. Accordingly, the “module” and “unit” can be used interchangeably.

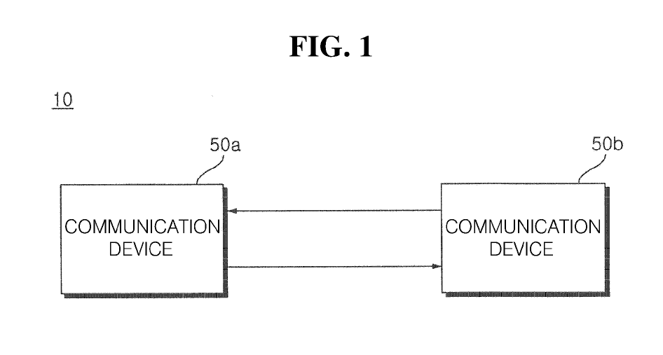

FIG. 1 is a diagram showing a concept of communication of a communication device according to an embodiment of the present invention.

Referring to the drawing, a first communication device 50a and a second communication device 50b may exchange data with each other.

To exchange data between the first communication device 50a and the second communication device 50b, pairing or the like may be performed.

When any one of the first communication device 50a and the second communication device 50b accesses the other one or is pointed at the other one, the first communication device 50a of the first communication device 50a and the second communication device 50b may transmit a pairing request signal to the second communication device 50b and the second communication device 50b may transmit a pairing response signal to the first communication device 50a in response to the pairing request signal.

The pairing request signal may include device information, frequency information, available frequency channel information, and so on of the first communication device 50a.

The pairing response signal may include frequency channel information and so on, which are selected from the device information and the available frequency channel information of the second communication device 50b.

Each communication device may be arranged and used in another electronic device. In particular, a communication device may be arranged and used in a portable device such as a mobile terminal or a remote control device.

When a communication device is disposed in another electronic device, it becomes important to recognize position information of the corresponding electronic device.

For example, after recognizing position information and device information, the communication device may perform remote control or the like on the corresponding electronic device.

An example of a positioning method for recognizing position information of an electronic device including an external communication device may include a method using a time difference of arrival (TDoA) based on a time of arrival and a trigonometric equation, a time of arrival (TOA) obtained by calculating time taken for a radio wave to arrive, an angle of arrival (AoA) using a transmitted signal angle, and received signal strength indication (RSSI), and a Wi-Fi positioning scheme using a radio AP.

The present invention proposes a method of accurately calculating position information of an external communication device in the angle of arrival (AoA) method using a transmitted signal angle thereamong.

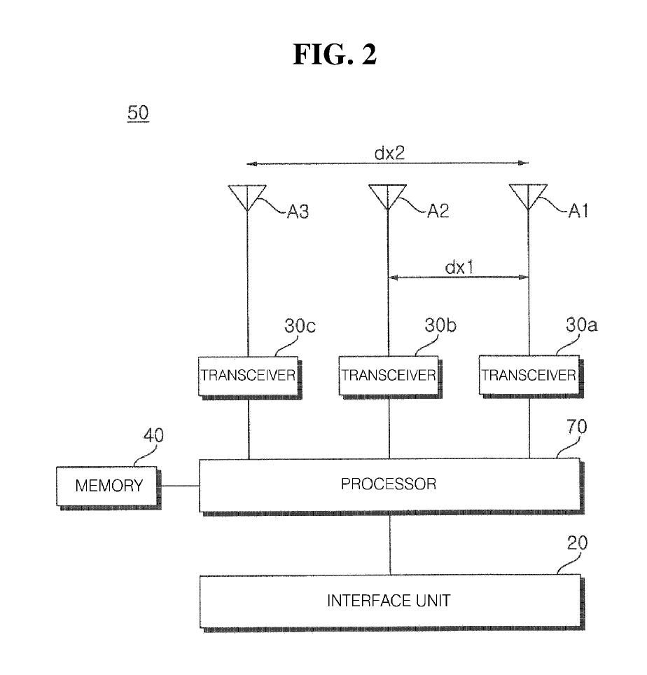

Hereinafter, as an internal block diagram of the first communication device 50a and the second communication device 50b, an internal block diagram of a communication device 50 of FIG. 2 is described.

FIG. 2 is an internal block diagram of an example of the communication device of FIG. 1.

Referring to the drawing, the communication device 50 of FIG. 1 may include first to third antennas A1, A2, and A3, first to third transceivers 30a, 30b, and 30c, and a processor 70.

The communication device 50 of FIG. 1 may further include a memory 40 for storing data required for an operation of the communication device 50, an interface unit 20 for wired access with an external device, and so on.

The first to third antennas A1, A2, and A3 may be arranged to be spaced apart from each other.

The first to third transceivers 30a, 30b, and 30c may access the first to third antennas A1, A2, and A3, respectively, to output transmit signals to the first to third antennas A1, A2, and A3 or to receive received signals from the first to third antennas A1, A2, and A3.

The processor 70 may control the first to third transceivers 30a, 30b, and 30c. In addition, the processor 70 may further control the memory 40, the interface unit 20, and so on.

The processor 70 may calculate a first phase difference based on a difference between a first received signal received by the first antenna A1 and a second received signal received by the second antenna A2, may calculate a second phase difference based on a difference between the first received signal received by the first antenna A1 and a third received signal received by the third antenna A3, and may calculate position information of an external communication device based on the first phase difference and the second phase difference. Accordingly, the position information of the external communication device may be accurately calculated.

In particular, the processor 70 may calculate angle information of the position information of the external communication device based on the first phase difference and the second phase difference. As such, in the angle of arrival (AoA) method using a transmitted signal angle, the position information of the external communication device may be accurately calculated.

The processor 70 may control the first antenna A1 to output a transmit signal based on the first received signal and may calculate distance information of the external communication device based on a time difference between the transmit signal and a fourth received signal received by the first antenna A1, in response to the transmit signal. Accordingly, the distance information and angle information of the external communication device may be calculated.

The processor 70 may repeatedly calculate the aforementioned position information.

For example, the processor 70 may calculate a third phase difference based on a difference between a fourth received signal received by the first antenna A1 and a fifth received signal received by the second antenna A2, may calculate a fourth phase difference based on a difference between the fourth received signal received by the first antenna A1 and a sixth received signal received by the third antenna A3, and may calculate position information of the external communication device based on the third phase difference and the fourth phase difference, in response to the transmit signal.

The processor 70 may perform signal processing on a received signal with a highest level among a plurality of received signals received by the first antenna A1. Accordingly, the communication device may perform optimum data communication with a pointed external communication device or a nearest external communication device.

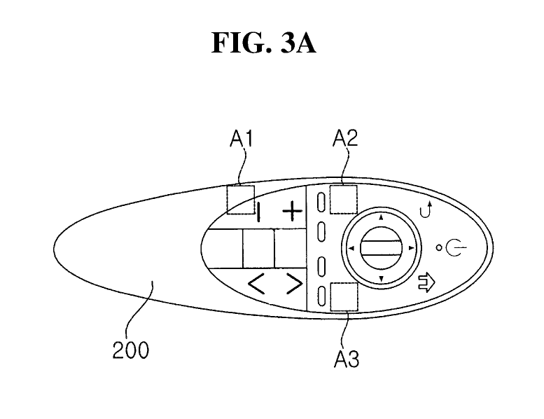

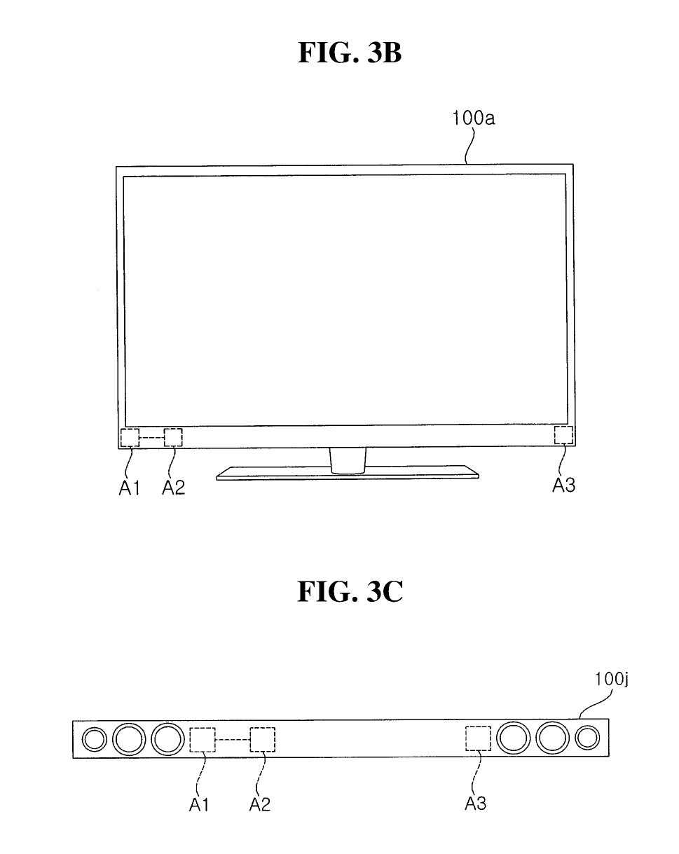

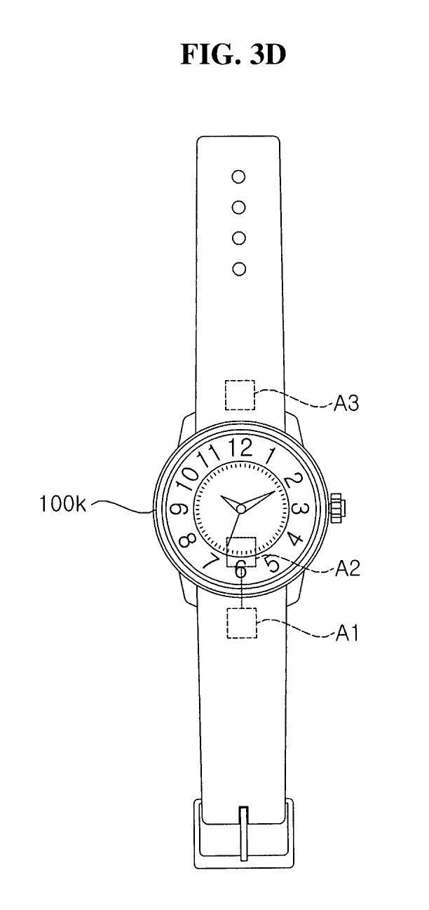

FIGS. 3A to 3D show various examples of an electronic device including the communication device of FIG. 1 or 2.

The communication device 50 according to an embodiment of the present invention may be employed in various electronic devices.

FIG. 3A shows an example of arrangement of the first to third antennas A1, A2, and A3 in a remote control device 200. In particular, in the drawing, the first to third antennas A1, A2, and A3 are arranged to be spaced apart from each other by different distances.

In addition, the remote control device 200 may further include components in the communication device 50, described with reference to FIG. 2, for example, the first to third transceivers 30a, 30b, and 30c, the processor 70, the memory 40, and the interface unit 20.

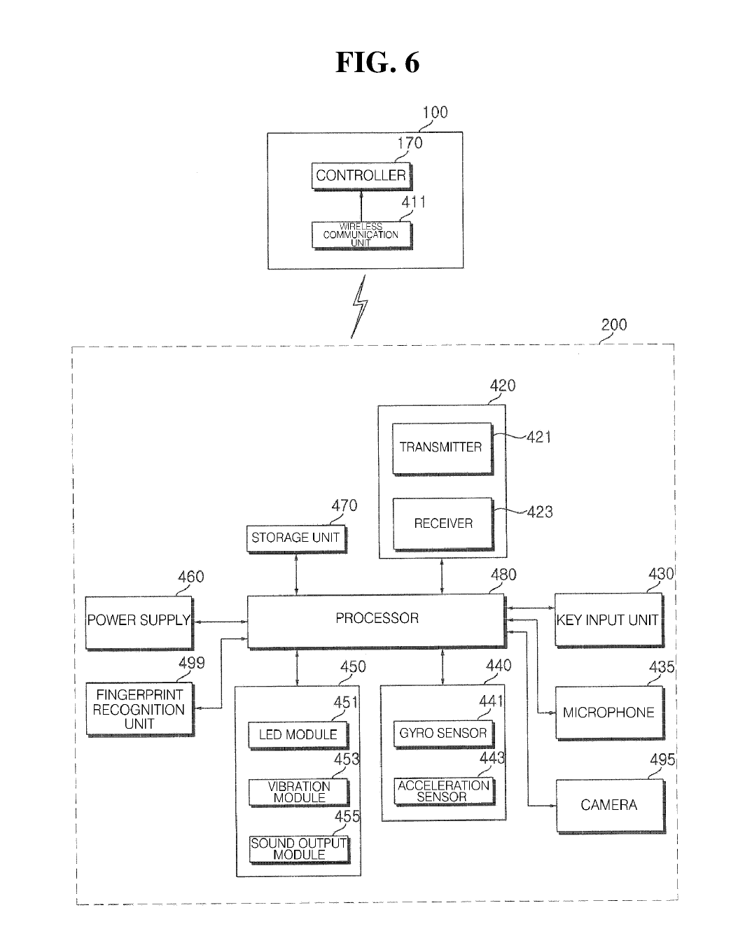

The remote control device 200 of FIG. 3A may be paired with a communication device in another pointed electronic device and may exchange data with the paired electronic device. In this case, position information of another electronic device, in particular, angle information (relative angle information), and distance information (relative distance information) may be calculated by the processor 70 in the communication device 50 or a processor 480 (refer to FIG. 6) in the remote control device 200, as described with reference to FIG. 2.

FIG. 3B shows an example of arrangement of the first to third antennas A1, A2, and A3 in a fixed type image display apparatus 100a such as a television (TV) or a monitor. In particular, in the drawing, the first to third antennas A1, A2, and A3 are arranged to be spaced apart from each other by different distances.

The image display apparatus 100a may include the communication device 50 described with reference to FIG. 2 for pairing and data communication with the remote control device 200 or a mobile terminal (not shown).

In particular, the image display apparatus 100a may further include components in the communication device 50, described with reference to FIG. 2, for example, the first to third transceivers 30a, 30b, and 30c, the processor 70, the memory 40, and the interface unit 20.

FIG. 3C shows an example of arrangement of the first to third antennas A1, A2, and A3 in an audio output device 100. In particular, in the drawing, the first to third antennas A1, A2, and A3 are arranged to be spaced apart from each other by different distances.

The audio output device 100 may include the communication device 50 described with reference to FIG. 2 for pairing and data communication with the remote control device 200 or a mobile terminal (not shown).

In particular, the audio output device 100 may further include components in the communication device 50, described with reference to FIG. 2, for example, the first to third transceivers 30a, 30b, and 30c, the processor 70, the memory 40, and the interface unit 20.

FIG. 3D shows an example of arrangement of the first to third antennas A1, A2, and A3 in a smart watch 100k as a wearable device. In particular, in the drawing, the first to third antennas A1, A2, and A3 are arranged to be spaced apart from each other by different distances.

The smart watch 100k may include the communication device 50 described with reference to FIG. 2 for pairing and data communication with a mobile terminal (not shown) or another electronic device.

In particular, the smart watch 100k may further include components in the communication device 50, described with reference to FIG. 2, for example, the first to third transceivers 30a, 30b, and 30c, the processor 70, the memory 40, and the interface unit 20.

In addition to the description of FIG. 3A to 3D, the communication device 50 described with reference to FIG. 2 may be employed in various electronic devices, for example, a mobile terminal such as a smart phone, smart glasses, an illumination device, an air conditioning device such as an air conditioner and an air purifier, a laundry processing device such as a washing machine and a dryer, a refrigerator, a robot cleaner, a drone, a vehicle, an energy storage device, an energy generating device such as a solar module, and a temperature adjusting device.

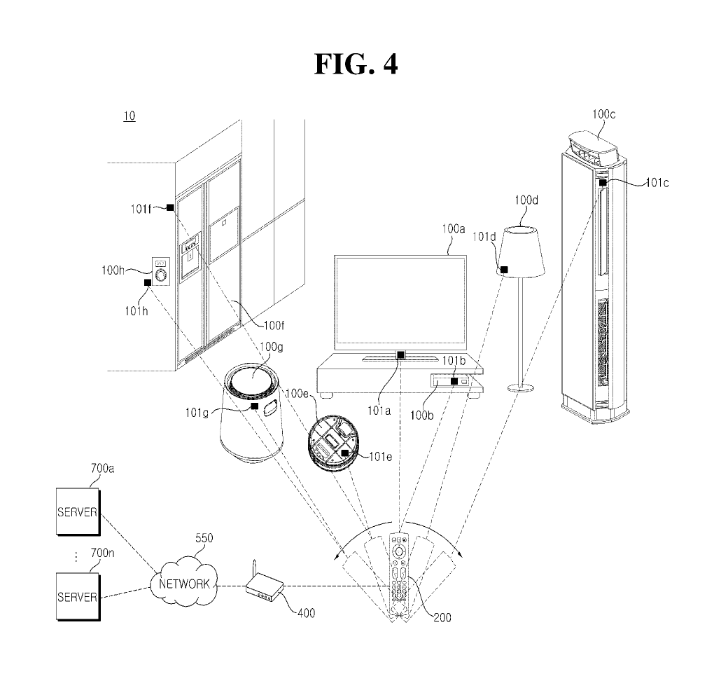

FIG. 4 is a diagram showing a device remote control system using the remote control device of FIG. 3A.

Referring to FIG. 4, according to an embodiment of the present invention, a device remote control system 10 may include the remote control device 200, a plurality of devices 100a, 100b, 100c, 100d, 100e, 100f, 100g, and 100h, and transmitting apparatuses 101a, 101b, 101c, 101d, 101e, 101f, 101g, and 101h that are installed in the respective devices or are arranged around the devices.

The device remote control system 10 may further include a gateway 400, servers 700a, . . . , 700n, and so on.

The drawing shows the device, for example, the image display apparatus 100a such as a TV, a set-top box 100b, an air conditioner 100c, an illumination device 100d, a robot cleaner 100e, a refrigerator 100f, an air purifier 100g, and a temperature control device 100h, but various other examples may be possible. The device illustrated in the drawing may be referred to as a home device.

An example of the device may further include a washing machine, an optical disc playback device, a game console, a gas valve, a security device such as a security camera, a door that is opened and closed in an electrical manner, a window that is opened and closed in an electrical manner, a sound output device, a game console, an electronic frame, an energy storage system (ESS), a digital camera, a scent generating device, a vehicle, a drone, and so on.

Hereinafter, a description is given in terms of devices illustrated in the drawings.

Each of the transmitting apparatuses 101a, 101b, 101c, 101d, 101e, 101f, 101g, and 101h may transmit a device identifier (ID) signal to be distinguished from another device.

The device ID signal may include at least one of device type information, manufacturer information, device model name information, device state information, or related information of a device control command for each device.

The device state information may include an on/off state of a device, an operation value state during a device operation, and so on.

The device ID signal may be a predetermined specific signal to identify each device. For example, the device ID signal may be a time-based pattern signal or a space-based pattern signal. In more detail, the device ID signal may be a time-based infrared pattern signal or a space-based infrared pattern signal.

Each of the transmitting apparatuses 101a, 101b, 101c, 101d, 101e, 101f, 101g, and 101h may reflect an output signal output from the pointed remote control device 200 and may transmit a device ID signal in a direction toward the remote control device 200.

The device ID signal may be a signal with excellent directivity and may be any one of an infrared signal, a radio frequency (RF) signal, a Wi-Fi signal, a ZigBee signal, a Bluetooth signal, a laser signal, and an ultra-wideband (UWB) signal.

The remote control device 200 may receive a plurality of ID signals from each of the transmitting apparatuses 101a, 101b, 101c, 101d, 101e, 101f, 101g, and 101h.

In this case, when the remote control device 200 is pointed at any one of the plurality of devices 100a, 100b, 100c, 100d, 100e, 100f, 100g, and 100h or any one of the plurality of transmitting apparatuses 101a, 101b, 101c, 101d, 101e, 101f, 101g, and 101h, the remote control device 200 may detect one ID signal from the at least one received ID signal, as a representative ID signal.

The remote control device 200 may perform signal processing on the detected ID signal or the representative ID signal and may verify or identify a device corresponding to the ID signal based on at least one of device type information, manufacturer information, device model name information, device state information, and related information of a device control command, which are included in the detected ID signal.

The remote control device 200 may compare the detected ID signal or the representative ID signal with data related to an ID signal that is pre-stored in the remote control device 200 to verify or identify a corresponding device.

The remote control device 200 may match at least some of a plurality of keys included therein with a control command for control of the verified device. The remote control device 200 may set at least some of the plurality of keys included in the remote control device 200 as a specific operation key for corresponding device control.

After control command setting or key setting for device control, when any one of a plurality of keys is selected by a user, the remote control device 200 may output and transmit a signal corresponding to a control command of the selected key, that is, a remote control signal.

For example, when the remote control device 200 is pointed at the air conditioner 100c, the remote control device 200 may match a first key of a plurality of keys to a control command for wind speed control of an air conditioner and may output and transmit a remote control signal related to wind speed control of an air conditioner during execution of the first key.

As a result, when pointed at a first device, the remote control device 200 may detect a first ID signal received from the first device and may match at least one of a plurality of keys with a control command for remote control of the first device based on the detected first ID signal and, when pointed at a second device, the remote control device 200 may detect a second ID signal received from the second device and may match at least one of a plurality of keys with a control command for remote control of the second device based on the detected second ID signal.

Accordingly, it may be possible to remotely control various devices using one remote control device 200.

That is, it may be possible to remotely control the image display apparatus 100a such as a TV, the set-top box 100b, the air conditioner 100c, the illumination device 100d, the robot cleaner 100e, the refrigerator 100f, the air purifier 100g, the temperature control device 100h, and so on according to a direction in which the remote control device 200 is pointed.

A remote control signal output from the remote control device 200 may be any one of an infrared signal, a radio frequency (RF) signal, a Wi-Fi signal, a ZigBee signal, a Bluetooth signal, a laser signal, and an ultra-wideband (UWB) signal.

The remote control device 200 may receive control command information of at least some of a plurality of keys from the gateway 400 for remote control of each device.

The remote control device 200 may transmit control command information of at least some of a plurality of keys to the gateway 400 for remote control of each device.

In particular, the gateway 400 may receive control command information of at least some of a plurality of keys from external servers 700a, . . . , 700n, or the like through a network 550 for remote control of each device.

In this case, the external servers 700a, . . . , 700n may be a server managed by a manufacturer of each device, a server for storing information on each device, or the like.

Each of the aforementioned transmitting apparatuses 101a, 101b, 101c, 101d, 101e, 101f, 101g, and 101h may be different from the communication device of FIG. 2 but may conceptually include the communication device 50 of FIG. 2.

The remote control device 200 may include the communication device 50 of FIG. 2 and may perform the same operation as the description of FIG. 2.

The present invention proposes a remote control device for more simply remotely controlling a plurality of devices.

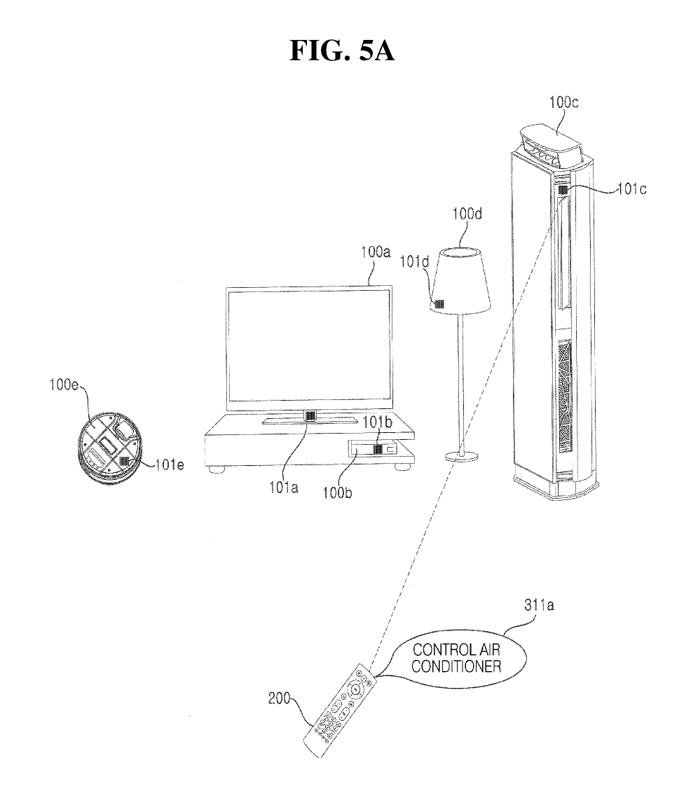

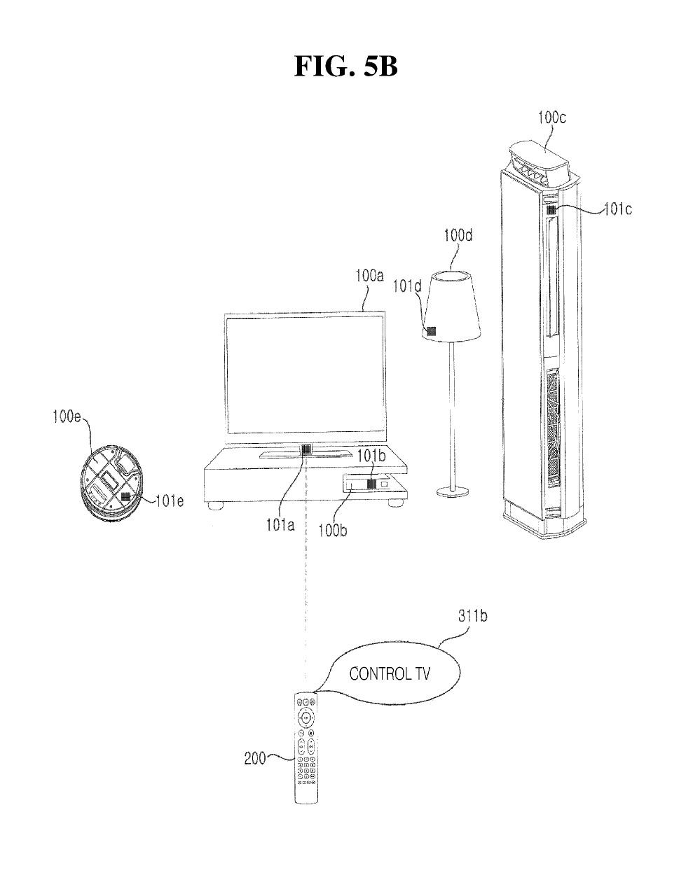

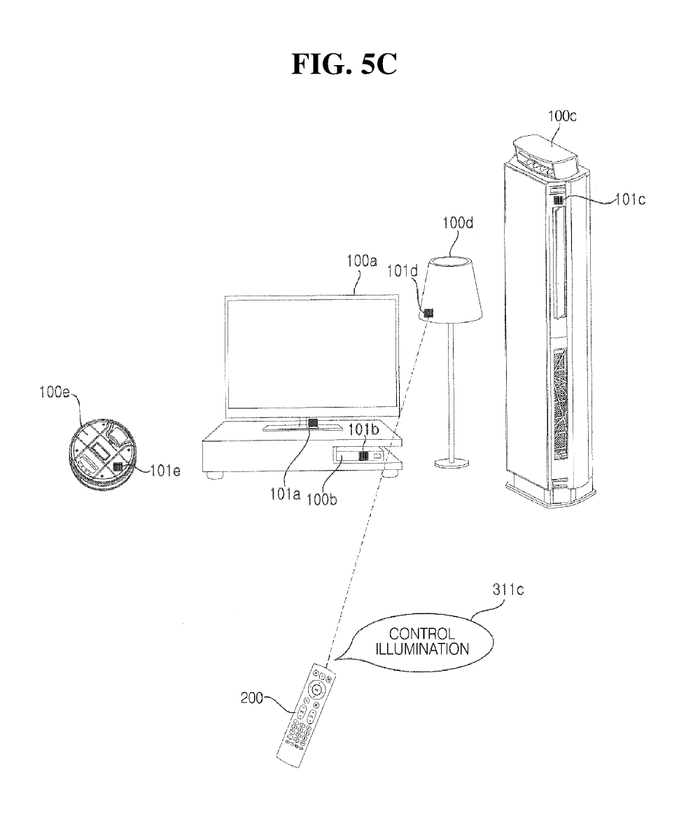

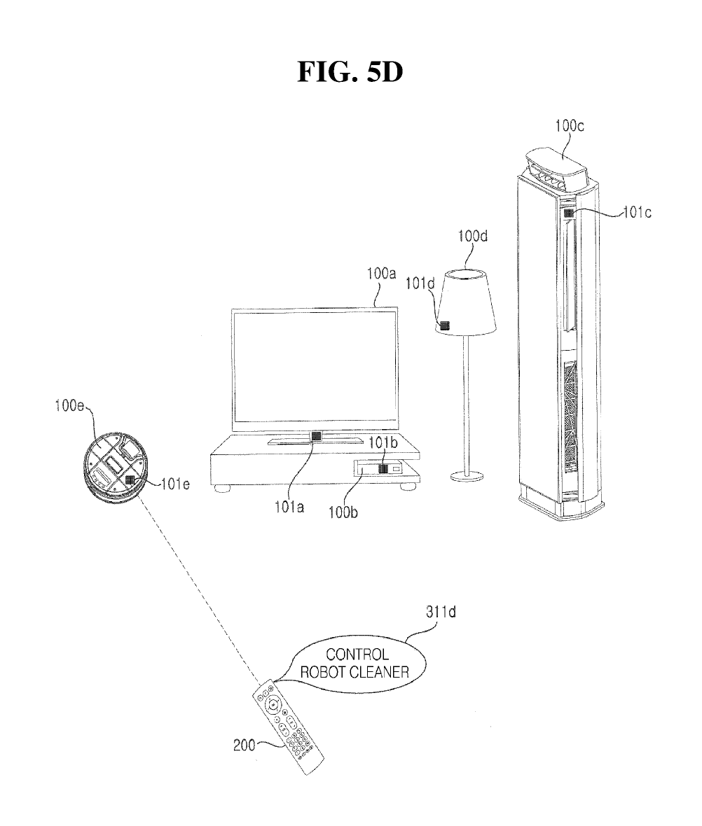

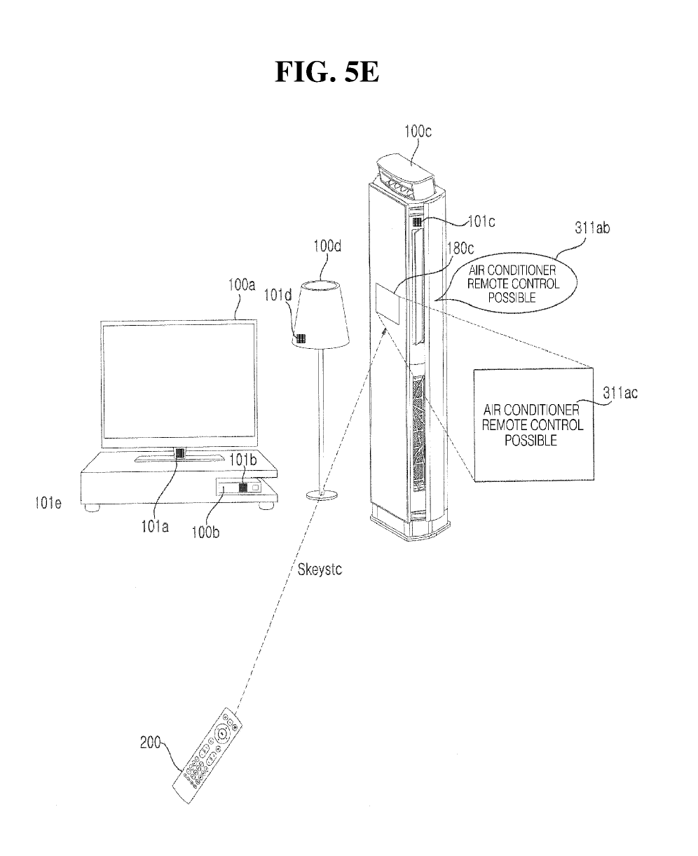

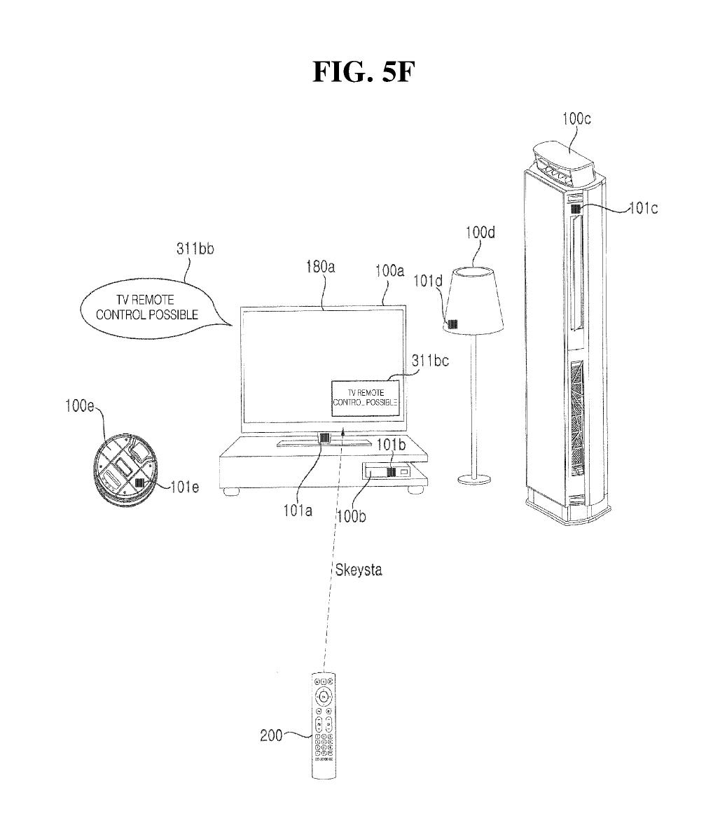

FIGS. 5A to 5F are diagrams showing an example of the case in which a type of a controlled device is changed according to a pointed direction of the remote control device of FIG. 4.

FIG. 5A shows an example of the case in which the remote control device 200 is directed in a direction toward the air conditioner 100c among various devices 100a, 100b, 100c, 100d, and 100e in the home.

The remote control device 200 may receive at least one ID signal including an ID signal from a transmitting device 101c, corresponding to the air conditioner 100c. The remote control device 200 may detect an ID signal from the at least one received ID signal and may verify or identify that a remotely controllable device is the air conditioner 100c based on the detected ID signal.

For example, when at least one of device type information, manufacturer information, and device model name information is included in the detected ID signal, the remote control device 200 may perform signal processing on an ID signal, may extract at least one of device type information, manufacturer information, and device model name information, and may verify or identify a device corresponding to the ID signal based on at least one of the extracted device type information, manufacturer information, and device model name information.

As another example, when the received and detected ID signal is a specific signal that is set to identify each device, the remote control device 200 may compare the received and detected ID signal with data related to an ID signal stored in a storage unit 470 to verify or identify the device.

In more detail, when the received and detected ID signal is a time-based pattern signal, the remote control device 200 may compare data related to the time-based pattern signal, stored in the storage unit 470, with the received pattern signal to verify or identify the device.

When the received and detected ID signal is a space-based pattern signal, the remote control device 200 may compare data related to the space-based pattern signal, stored in the storage unit 470, with the received pattern signal to verify or identify the device.

As described with reference to FIG. 2, the remote control device 200 may verify or identify a device at a pointed position based on position information recognized by the communication device 50, in particular, distance information and angle information.

In this case, information on a nearby device may be pre-stored in a memory or the like and the remote control device 200 may lastly verify or identify an electronic device at a pointed position, i.e., a corresponding device using pre-stored surrounding electronic device information and calculated position information.

The remote control device 200 may match at least some of a plurality of keys with a control command of the air conditioner 100c after a pointed device is identified as the air conditioner 100c.

When a predetermined device is completely identified or key setting is completed based on detection of the ID signal, the remote control device 200 may output a device controllable message 311a in the form of sound, may emit light through a light emitting diode (LED) included in a device controllable message 311a for a predetermined time period, may output vibration, or may perform other operations. As such, a user may recognize that an air conditioner is capable of being controlled. In FIG. 3A shows the case in which the air conditioner controllable message 311a such as “Control Air Conditioner” is output in the form of sound.

For user convenience, a device that is completely identified by the remote control device 200 or is controllable, the device may emit light through an LED included in the device or a transmitting device for a predetermined time period, may output specific sound through an audio device included in the device or the transmitting device, or may display a remote control function device, or the like of the remote control device 200 through a display included in the device or the transmitting device.

In particular, when a specific key of the remote control device 200 is executed after key setting is completed, the remote control device 200 may transmit a remote control signal corresponding to a control command of the corresponding key to the air conditioner 100c.

After receiving a remote control signal, the air conditioner 100c may emit light through an LED installed in the air conditioner 100c for a predetermined time period. As such, the user may recognize that the air conditioner is currently controlled.

FIG. 5B illustrates an example of the case in which the remote control device 200 is pointed at the image display apparatus 100a among various devices 100a, 100b, 100c, 100d, and 100e in the home.

The remote control device 200 may receive an ID signal from a transmitting device 101a corresponding to the image display apparatus 100a.

The remote control device 200 may detect an ID signal from at least one of ID signals including the ID signal received from the image display apparatus 100a and may verify or identify that a remotely controllable device is the image display apparatus 100a based on the detected ID signal. A method of verifying the image display apparatus 100a may be understood from FIG. 5A and, thus, a description thereof is omitted herein.

After verifying that a pointed device is the image display apparatus 100a, the remote control device 200 may match at least some of a plurality of keys with a control command of the image display apparatus 100a.

FIG. 5C is a diagram showing an example of the case in which the remote control device 200 is pointed at the illumination device 100d among various devices 100a, 100b, 100c, 100d, and 100e in the home.

The remote control device 200 may receive an ID from a transmitting device 101d corresponding to the illumination device 100d, for example, an infrared (IR) signal.

The remote control device 200 may verify that a pointed device is the illumination device 100d based on the infrared (IR) signal. A method of verifying the illumination device 100d may be understood from FIG. 5A and, thus, a description thereof is omitted herein.

After verifying that a pointed device is the illumination device 100d, the remote control device 200 may match at least some of a plurality of keys with a control command of the illumination device 100d.

FIG. 5D is a diagram showing an example of the case in which the remote control device 200 is pointed at the robot cleaner 100e among various devices 100a, 100b, 100c, 100d, and 100e in the home.

The remote control device 200 may receive an ID signal from a transmitting device 101e, corresponding to the robot cleaner 100e.

The remote control device 200 may detect an ID signal from at least one ID signal including an ID signal received from the robot cleaner 100e and may verify or identify that a remotely controllable device is the robot cleaner 100e based on the detected ID signal. A method of verifying the robot cleaner 100e may be understood from FIG. 5A and, thus, a description thereof is omitted herein.

After verifying that a pointed device is the robot cleaner 100e, the remote control device 200 may match at least some of a plurality of keys with a control command of the robot cleaner 100e.

FIG. 5E is a diagram showing an example of the case in which the remote control device 200 transmits a remotely controllable signal (Skeystc) to the air conditioner 100c after setting for remote control of the air conditioner 100c is completed.

After receiving the remotely controllable signal (Skeystc), the air conditioner 100c may display an air conditioner remote controllable message 311ac on a display 180c or may output an air conditioner remote controllable message 311ab in the form of sound.

That is, differently from FIG. 5A, the remote control device 200 may transmit the remotely controllable signal (Skeystc) to the air conditioner 100c and, then, the air conditioner 100c may output the air conditioner remote controllable messages 311ab and 311ac instead of outputting the air conditioner controllable message 311a such as “Control Air Conditioner”.

FIG. 5F is a diagram showing an example of the case in which the remote control device 200 transmits a remotely controllable signal (Skeysta) to the image display apparatus 100a after setting of remote control of the image display apparatus 100a is completed.

The image display apparatus 100a may receive the remotely controllable signal (Skeysta) and, then, may display an image display device remote controllable message 311bc on a display 180a or may output an image display device remote controllable message 311bb in the form of sound.

FIG. 6 is an internal block diagram of the remote control device of FIG. 4.

Referring to the drawing, the remote control device 200 may include a wireless communication unit 420, a key input unit 430, a microphone 435, a sensor unit 440, an output unit 450, a power supply 460, the storage unit 470, a processor 480, a camera 495, and a fingerprint recognition unit 499.

Here, the wireless communication unit 420 may include the communication device 50 of FIG. 2.

As described above, the wireless communication unit 420 may transmit and receive a signal to and from any one of the devices. To this end, the wireless communication unit 420 may include a receiver 423 and a transmitter 421.

In the present embodiment, the remote control device 200 may include the receiver 423 for receiving a device ID signal and the transmitter 421 for outputting a remote control signal, an output signal, or a call signal.

The receiver 423 may receive any one device ID signal of an infrared signal, a radio frequency (RF) signal, a Wi-Fi signal, a ZigBee signal, a Bluetooth signal, a laser signal, and an ultra-wideband (UWB) signal from a transmitting device 101.

The transmitter 421 may output any one remote control signal of an infrared signal, a radio frequency (RF) signal, a Wi-Fi signal, a ZigBee signal, a Bluetooth signal, a laser signal, and an ultra-wideband (UWB) signal.

The transmitter 421 may output different remote control signals for a plurality of devices, respectively. For example, when a remote control signal is output as an IR signal, IR signals with different patterns or different frequency bands may be output.

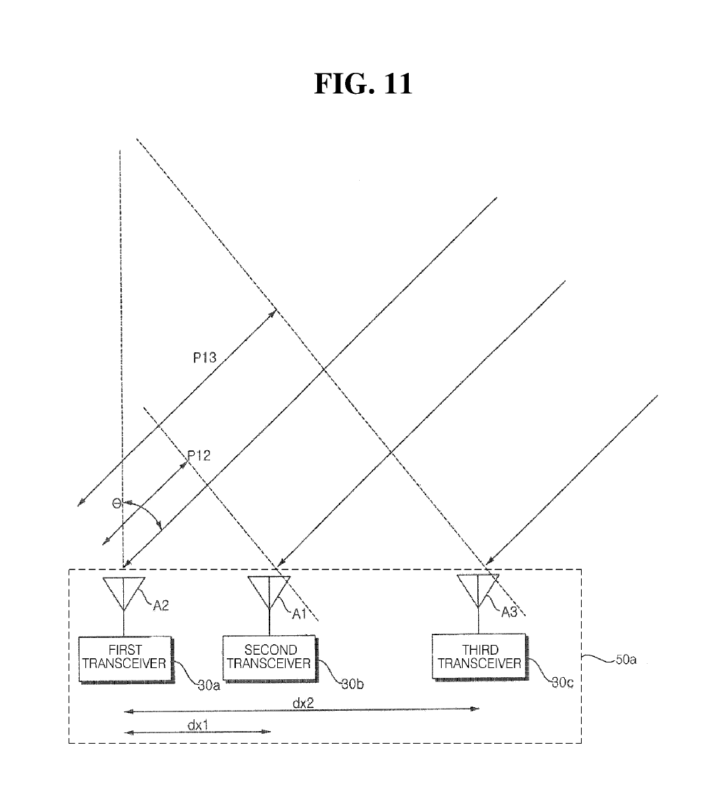

The transmitter 421 may output an output signal Sout in response to the case of FIG. 11A. In this case, the output signal Sout may be any one of an infrared signal, a radio frequency (RF) signal, a Wi-Fi signal, a ZigBee signal, a Bluetooth signal, a laser signal, and an ultra-wideband (UWB) signal.

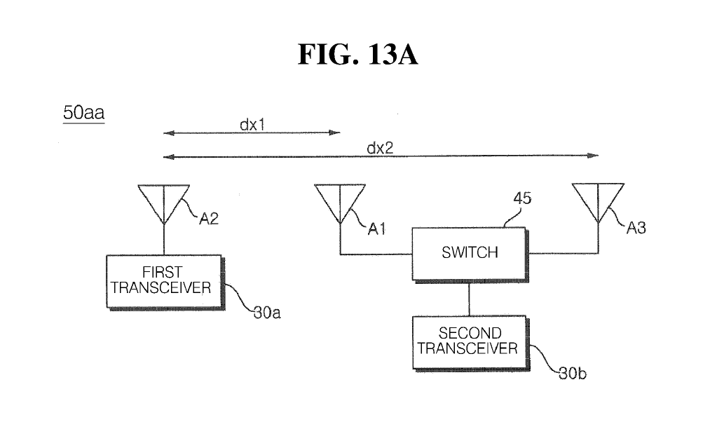

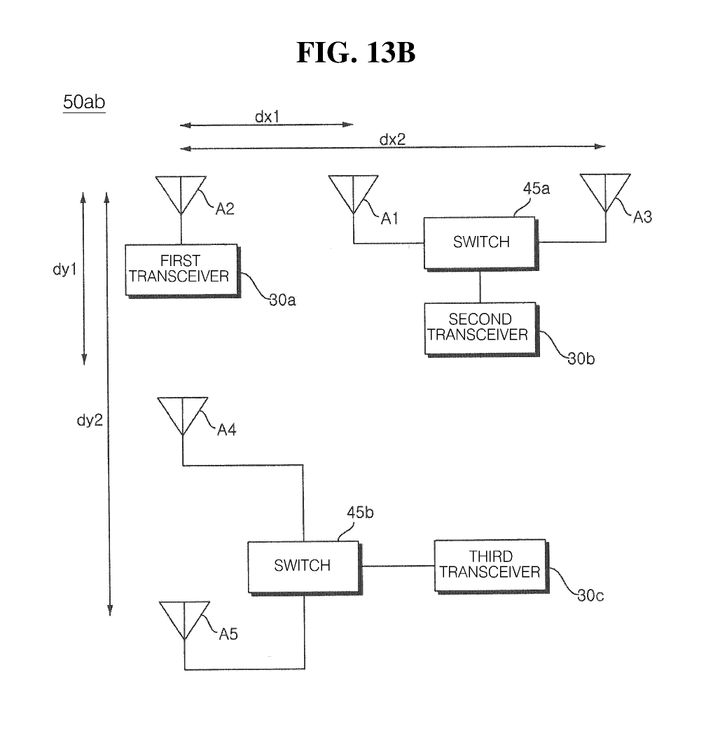

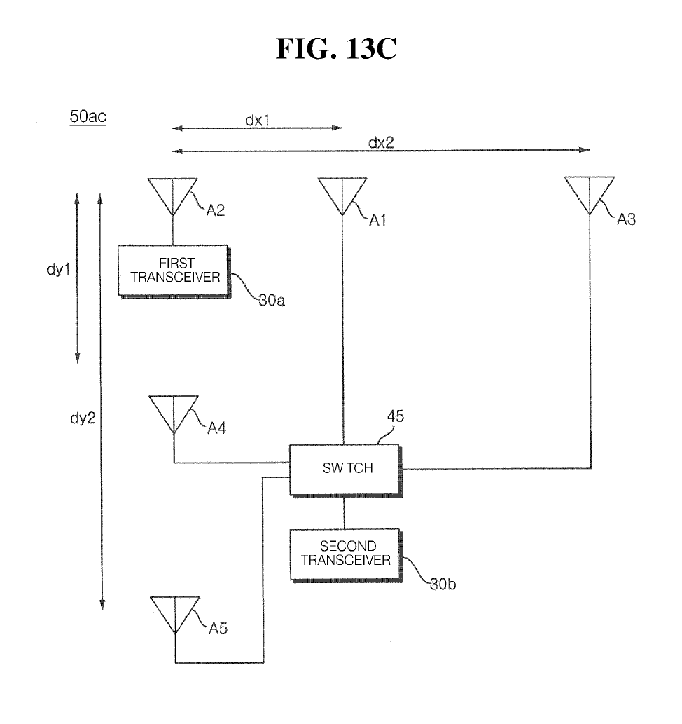

The transmitter 421 may output a call signal Scall in response to the case of FIG. 13A. In this case, the call signal Scall may be any one of an infrared signal, a radio frequency (RF) signal, a Wi-Fi signal, a ZigBee signal, a Bluetooth signal, a laser signal, and an ultra-wideband (UWB) signal.

When a corresponding device is the image display apparatus 100a, the remote control device 200 may transmit pointing information of the remote control device 200, e.g., a signal including information on movement, and so on.

The key input unit 430 may include a plurality of keys. The plurality of keys may be embodied as a key pad, a button, a touch pad, a touchscreen, or the like.

The microphone 435 may receive user voice, may convert the received user voice into an electric signal, and may transmit the electric signal to the processor 480.

The sensor unit 440 may include a gyro sensor 441 or an acceleration sensor 443. The gyro sensor 441 may sense information on movement of the remote control device 200.

For example, the gyro sensor 441 may sense information on an operation of the remote control device 200 based on the x, y, and z axes. The acceleration sensor 443 may sense information on moving speed or the like of the remote control device 200.

The output unit 450 may output a vibration or sound signal corresponding to manipulation of the key input unit 430 or emit light through an LED, corresponding thereto. A user may recognize whether the key input unit 430 is manipulated, through the output unit 450.

For example, the output unit 450 may include an LED module 451, a vibration module 453, and a sound output module 455 and, in this case, the LED module 451 may be driven, the vibration module 453 may generate vibration, and the sound output module 455 may output sound, when the key input unit 430 is manipulated or an IR signal is transmitted or received through the wireless communication unit 420.

The power supply 460 may supply power to the remote control device 200. When the remote control device 200 does not move for a predetermined time period, the power supply 460 may stop power supply to reduce power waste. The power supply 460 may restart power supply when a predetermined key included in the remote control device 200 is manipulated.

The storage unit 470 may store various types of programs, application data, and so on, which are required for control or an operation of the remote control device 200.

In particular, the storage unit 470 may store a plurality of device information items or a plurality of device ID information items. A processor may verify or identify a remotely controllable device based on the plurality of stored device information items or plurality of device ID information items and the detected ID information. The storage unit 470 may store pattern related data of a plurality of signals received from a plurality of devices. The storage unit 470 may store control command data for operation key setting for each device. In addition, the storage unit 470 may also store a signal pattern of an operation key for each device.

The processor 480 may control all matters related to control of the remote control device 200.

Upon receiving at least one ID signal including a device ID signal from at least one device or a transmitting device corresponding thereto, through the receiver 423, the processor 480 may detect an ID signal from the at least one received ID signal, may verify or identify the device based on the detected ID signal, may match at least one of a plurality of keys with a control command for remote control of the device, and may control the transmitter 421 to transmit a signal corresponding to the control command when a key matched with the control command is selected.

When a remote control device is pointed at a device, the processor 480 may identify the device based on the ID signal received from the device or the transmitting device corresponding thereto.

When the remote control device 200 is pointed at a first device, the processor 480 may detect a first ID signal from at least one ID signals including the first ID signal received from the first device and may match at least one of a plurality of keys with a control command for remote control of the first device based on the detected first ID signal and, when the remote control device 200 is pointed at a second device, the processor 480 may detect a second ID signal from at least one of ID signals including the second ID signal received from the second device and may match at least one of a plurality of keys with a control command for remote control of the second device based on the detected second ID signal.

The processor 480 may control the wireless communication unit 420 to transmit a signal corresponding to predetermined key manipulation of the key input unit 430 to a corresponding device through the wireless communication unit 420.

When the remote control device 200 is pointed at the image display apparatus 100a and identifies the image display apparatus 100a, and some of control keys are matched with a control command of the image display apparatus 100a, the processor 480 may transmit a signal corresponding to movement of the remote control device 200 or a pointing signal, sensed by the sensor unit 440, to the image display apparatus 100a through the wireless communication unit 420.

The camera 495 may capture an image. In particular, when the camera 495 is pointed at the user's face, the camera 495 may capture an image including the user's face.

The processor 480 may identify or verify a user based on the captured user's face image and pre-stored user image related data.

The fingerprint recognition unit 499 may capture an image including a user fingerprint. In this case, the processor 480 may identify or verify a user based on the captured user fingerprint image and pre-stored user fingerprint image related data.

The processor 480 may perform user authentication based on the image captured by the camera 495 and, when user authentication is successful, the processor 480 may perform control to remotely control a corresponding device.

The processor 480 may perform control to transmit user information to a device that is completely identified and is controllable and, upon receiving user authentication verifying information from the device, the processor 480 may perform control to remotely control the corresponding device.

The device 100 may include a wireless communication unit 411 for wirelessly transmitting and receiving a signal to and from the remote control device 200, and a controller 170 for control of an operation of a received radio signal.

The wireless communication unit 411 may wirelessly transmit and receive a signal to and from the remote control device 200. The wireless communication unit 411 may receive a signal that is transmitted by the remote control device 200 according to various communication standards.

The processor 480 of the remote control device 200 may calculate a first phase difference based on a difference between a first received signal received by the first antenna A1 and a second received signal received by the second antenna A2, may calculate a second phase difference based on a difference between the first received signal received by the first antenna A1 and a third received signal received by the third antenna A3, and may calculate position information of an external communication device based on the first phase difference and the second phase difference. As such, the position information of the external communication device may be accurately calculated.

In particular, the processor 480 of the remote control device 200 may calculate angle information of the position information of the external communication device based on the first phase difference and the second phase difference. As such, the position information of the external communication device may be accurately calculated using an angle of arrival (AoA) method based on a transmitted signal angle.

The processor 480 of the remote control device 200 may control the first antenna A1 to output a transmit signal based on the first received signal and may calculate distance information of the external communication device based on a time difference between the fourth received signal received by the first antenna A1 and the transmit signal, in response to the transmit signal. Accordingly, the distance and angle information of the external communication device may be calculated.

The processor 480 of the remote control device 200 may repeatedly perform the aforementioned calculation of the processor 480.

For example, the processor 480 of the remote control device 200 may calculate a third phase difference based on a difference between the fourth received signal received by the first antenna A1 and a fifth received signal received by the second antenna A2, may calculate a fourth phase difference based on a difference between the fourth received signal received by the first antenna A1 and a sixth received signal received by the third antenna A3, and calculate position information of the external communication device based on the third phase difference and the fourth phase difference, in response to the transmit signal.

The processor 480 of the remote control device 200 may perform signal processing on a received signal with a highest level among a plurality of received signals received by the first antenna A1. Accordingly, the processor 480 may perform optimum data communication with a pointed external communication device or the nearest external communication device.

As described with reference to FIG. 2, the processor 480 of the remote control device 200 may verify or identify a device at a pointed position based on position information recognized by the communication device 50, in particular, distance information and angle information.

In this case, information on a nearby device may be pre-stored in a memory or the like and the processor 480 of the remote control device 200 at a pointed position, i.e., a corresponding device using pre-stored surrounding electronic device information and calculated position information.

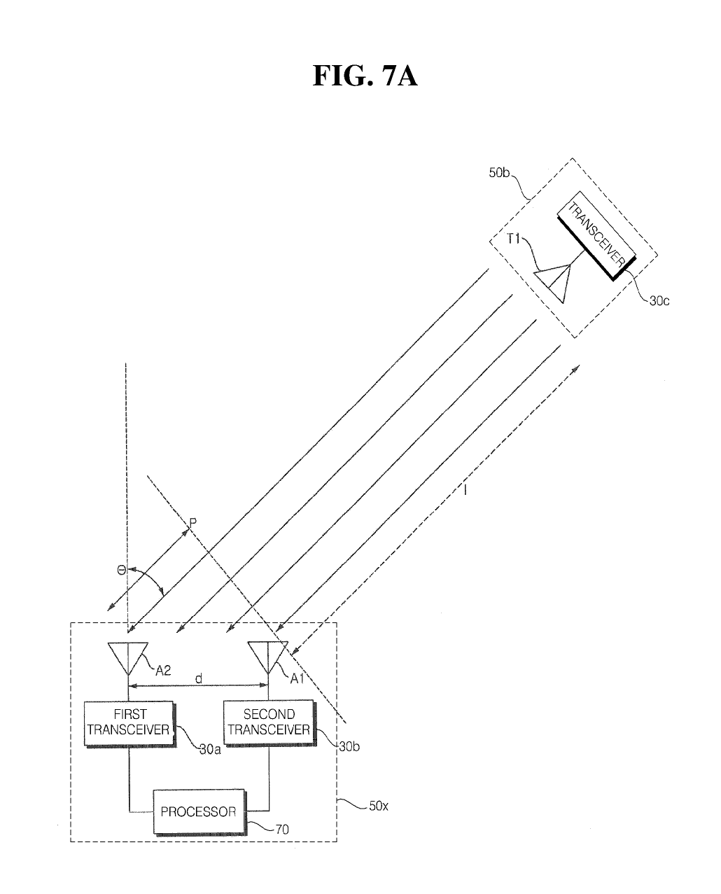

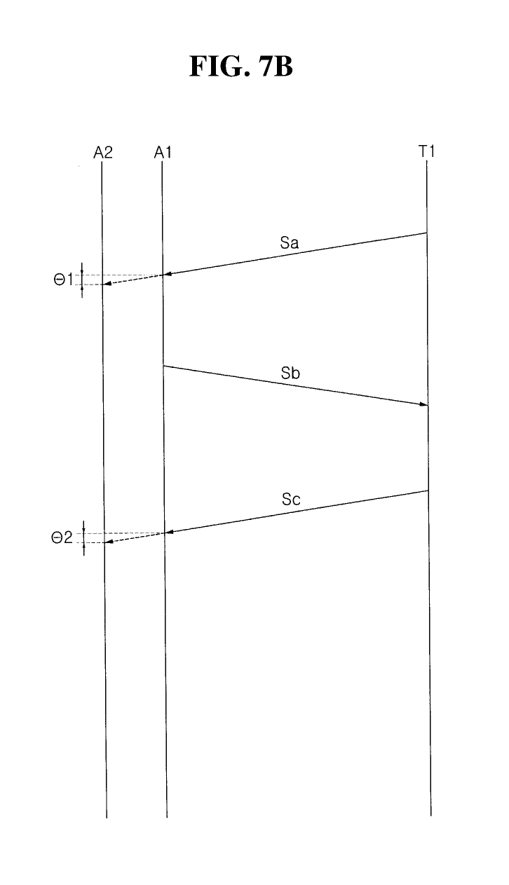

FIGS. 7A to 9D are diagrams for explanation of a communication device.

FIG. 7A shows an example of a communication device 50x including two antennas A1 and A2 that are spaced apart from each other by a predetermined distance d.

To use angle of arrival (AoA) in a positioning method, a plurality of transceivers including an antenna may be required.

Accordingly, FIG. 7A is a diagram showing an example of the communication device 50x including a first transceiver 30a and a second transceiver 30b that are connected to the first antenna A1 and the second antenna A2, and the first antenna A1 and the second antenna A2, respectively.

When an external communication device 50b transmits a transmit signal, the first antenna A1 and the second antenna A2 receive signals, respectively and, when a distance 1 is much longer than d or a received signal is configured in the form of a plane wave, an incident form shown in FIG. 7A may be realized.

The processor 70 may calculate angle information between the communication device 50x and the external communication device 50b using Equation 1 below.

$$sin θ = \frac{p}{d} \\ \frac{α}{2 π} = \frac{p}{λ} \\ θ = {sin}^{- 1} \frac{α λ}{2 π d} \qquad [ Equation 1 ]$$

FIG. 7B is a diagram showing a signal flow between the communication device 50x and the external communication device 50b.

When an antenna T1 of the external communication device 50b transmits a signal Sa to the communication device 50x, the processor 70 may calculate a phase difference θ1 of signals received by the first antenna A1 and the second antenna A2 of the communication device 50x.

When the first antenna A1 of the communication device 50x transmits a transmit signal Sb and the antenna T1 of the external communication device 50b transmits a signal Sc to the communication device 50x, the processor 70 may calculate a phase difference θ2 of signals received by the first antenna A1 and the second antenna A2 of the communication device 50x.

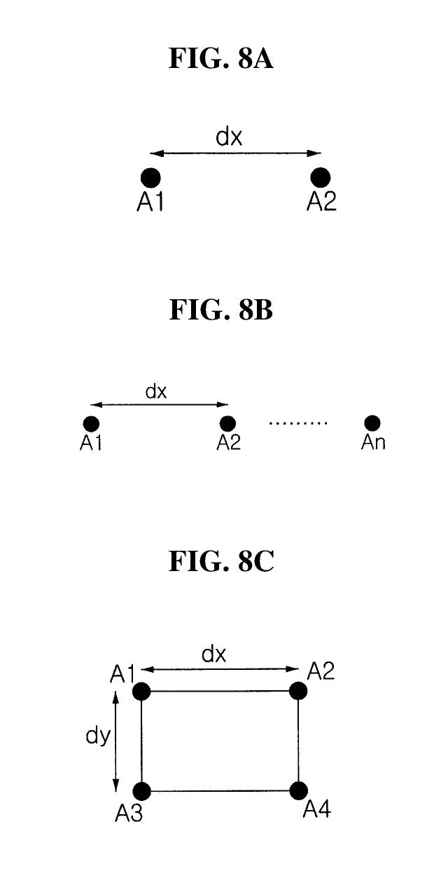

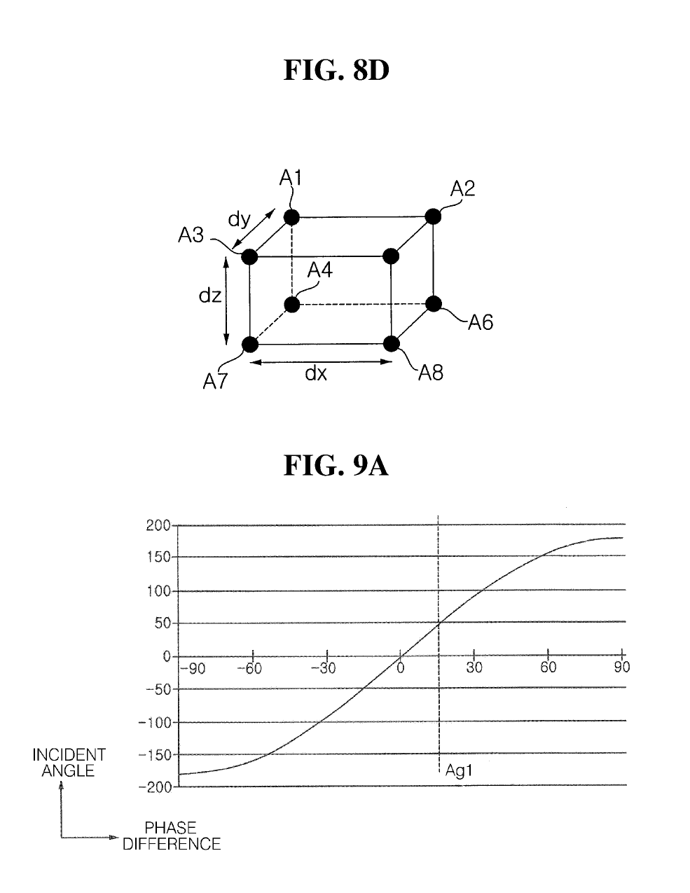

However, there is a limit in accuracy using the two transceivers 30a and 30b shown in FIGS. 7A and 7B and, thus, a communication device that requires high-accuracy positioning may be configured and used in such a way that two or more transceivers are linearly arranged in a straight line, in a two-dimensional (2D) plane, or in a 3D space, as shown in FIGS. 8A to 8D.

FIG. 8A illustrates an example of the case in which the two antennas A1 and A2 are arranged in a straight line. FIG. 8B illustrates an example of the case in which n antennas A1, A2, . . . , An are arranged in a straight line. FIG. 8C illustrates an example of the case in which four antennas A1, A2, A3, and A4 are arranged in a square plane. FIG. 8D illustrates an example of the case in which six antennas A1 to A6 are three-dimensionally arranged in a hexahedral form.

However, when antennas are arranged as shown in FIGS. 8A to 8D, if the antennas are spaced apart from each other at the same interval, the arrangement may be vulnerable to noise.

As an interval between receive antennas is increased, a change in signal phase difference is increased and an incident angle is more advantageously distinguished even in a noisy environment.

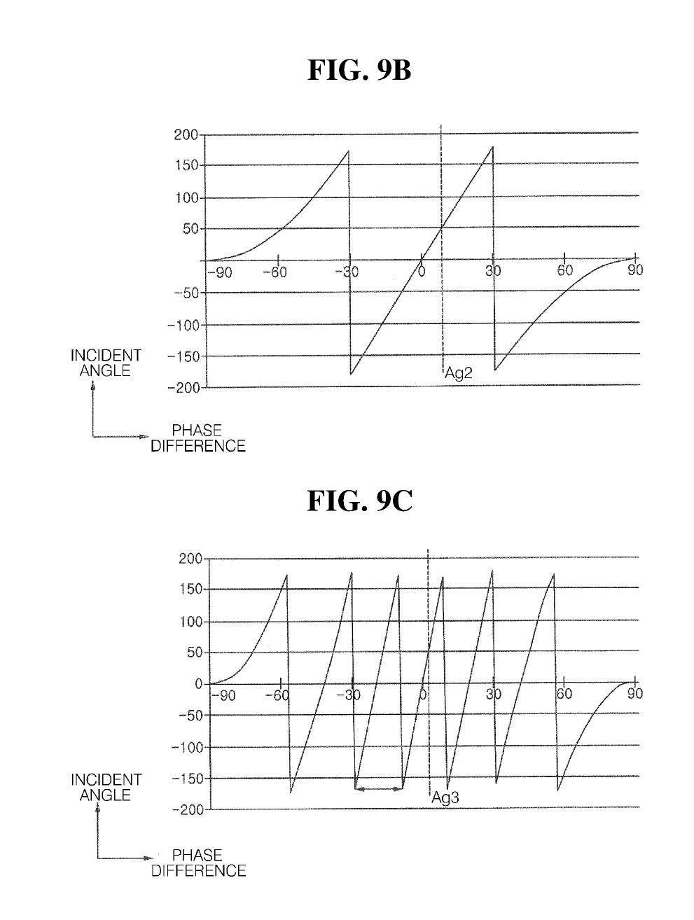

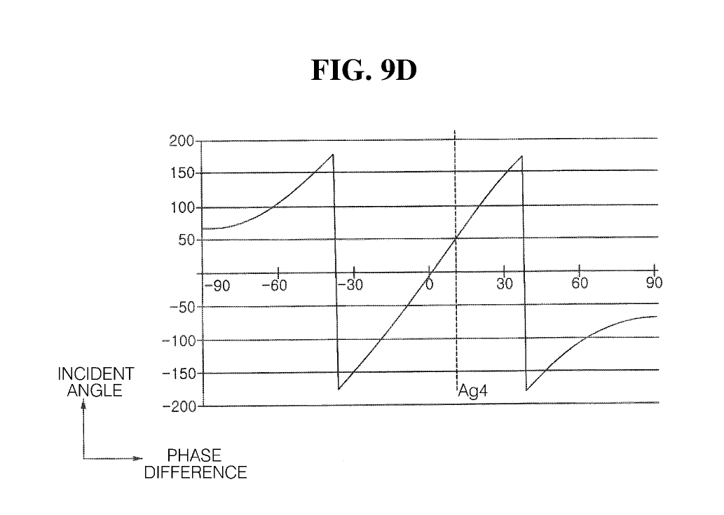

However, when antennas are arranged as shown in FIGS. 8A to 8D, if an interval between the antennas is increased, a plurality of solutions of an incident angle is calculated and it is difficult to recognize an actual solution among the calculated solutions, as shown in FIGS. 9A to 9D.

FIG. 9A is a diagram showing an example of the case in which an interval between the first antenna A1 and the second antenna A2 is half (0.5λ) a wavelength of a signal Sa or Sc.

FIG. 9B is a diagram showing an example of the case in which an interval between the first antenna A1 and the second antenna A2 is a wavelength λ of a signal Sa or Sc, FIG. 9C is a diagram showing an example of the case in which an interval between the first antenna A1 and the second antenna A2 is three times (3λ) of a wavelength of a signal Sa or Sc, and FIG. 9D is a diagram showing an example of the case in which an interval between the first antenna A1 and the second antenna A2 is 0.8125 times (0.8125λ) a wavelength of a signal Sa or Sc.

In FIGS. 9A to 9D, a horizontal axis is a phase difference between the first antenna A1 and the second antenna A2 and a vertical axis is an incident angle.

FIG. 9A illustrates an example of the case in which an incident angle is 50 degrees when a phase difference is Ag1. FIG. 9B illustrates an example of the case in which an incident angle is 50 degrees when a phase difference is Ag1. FIG. 9C illustrates an example of the case in which an incident angle is 50 degrees when a phase difference is Ag1. FIG. 9D illustrates an example of the case in which an incident angle is 50 degrees when a phase difference is Ag1.

When an interval between receive antennas is increased, a plurality of solutions of an incident angle as a target is calculated due to periodicity of a signal and it is difficult to recognize an actual solution among the calculated solutions.

When a signal phase difference is 0 degrees, two solutions are calculated as shown in FIG. 9B, when a signal phase difference is 0 degrees, five solutions are calculated as shown in FIG. 9C, and even if an interval between the first antenna A1 and the second antenna A2 is not an integer multiple, when a signal phase difference is 0 degrees, two solutions are calculated as shown in FIG. 9D.

Accordingly, the present invention states a communication device that is robust to noise and is capable of accurately calculating an incident angle.

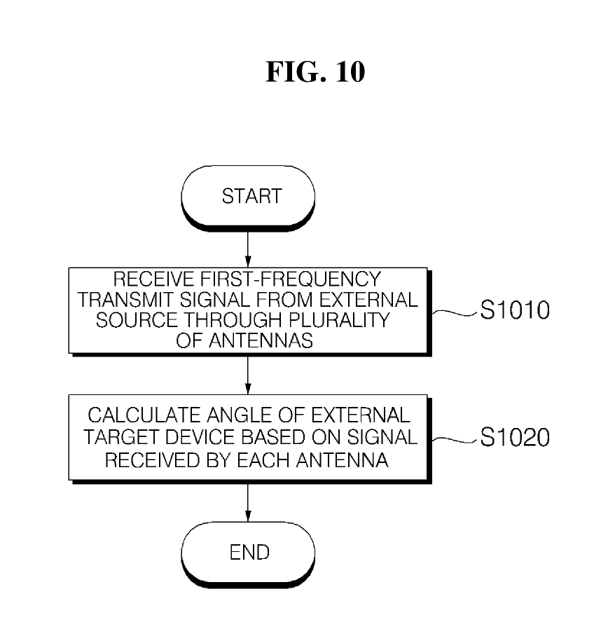

This is described below with reference to FIG. 10 and subsequent drawings.

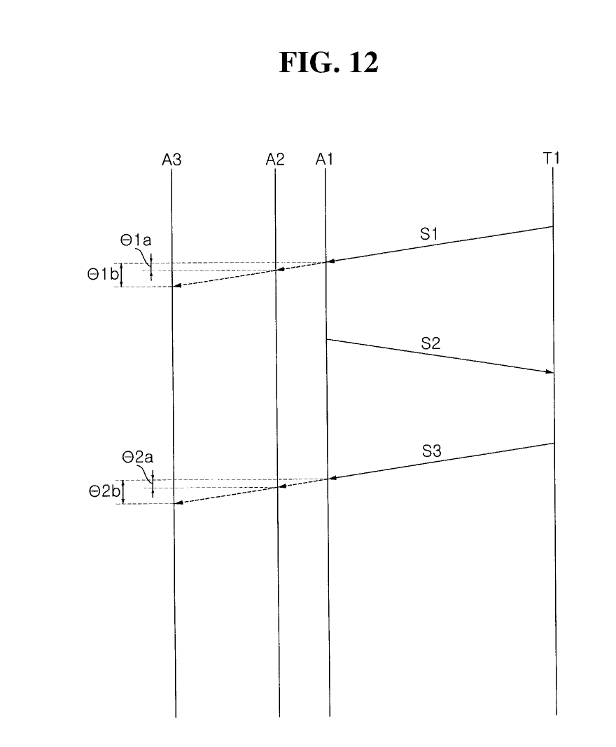

FIG. 10 is a diagram showing an example of an operation method of a communication device according to an embodiment of the present invention. FIG. 11 is an internal block diagram of an example of a communication device according to an embodiment of the present invention. FIG. 12 is a diagram for explanation of an operation of the communication device of FIG. 11.

First, referring to FIG. 10, the processor 70 in the communication device 50 may receive a first-frequency received signal from an external source through a plurality of antennas (S1010).

The processor 70 in the communication device 50 may calculate an angle of an external target device based on a signal received by each antenna (S1020).

As shown in FIG. 11, the communication device 50 may include the first to third antennas A1, A2, and A3 that are spaced apart from each other by different distances, the first to third transceivers 30a, 30b, and 30c that are connected to the first to third antennas A1, A2, and A3 and output transmit signals to the first to third antennas A1, A2, and A3 or receive received signals from the first to third antennas A1, A2, and A3, respectively, and the processor 70 for controlling the first to third transceivers 30a, 30b, and 30c.

A distance between the first antenna A1 and the second antenna A2 may be dx1 and a distance between the first antenna A1 and the third antenna A3 may be dx2.

For example, a distance between the first antenna A1 and the second antenna A2 may correspond to 0.5 times (0.5λ) a wavelength of each received signal and a distance between the first antenna A1 and the third antenna A3 may correspond to 1.5 times to 3 times (1.5λ to 3λ) a wavelength of each received signal.

As shown in FIG. 12, the first antenna A1, the second antenna A2, and the third antenna A3 may each receive a transmit signal S1 from the antenna T1 of the external communication device 50b. In this case, signals received by the first antenna A1, the second antenna A2, and the third antenna A3 may be referred to as a first received signal, a second received signal, and a third received signal, respectively.

The processor 70 may calculate a first phase difference θ1a based on a difference between a first received signal received by the first antenna A1 and a second received signal received by the second antenna A2, may calculate a second phase difference θ1b based on a difference between the first received signal received by the first antenna A1 and a third received signal received by the third antenna A3, and may calculate position information of the external communication device 50b based on the first phase difference θ1a and the second phase difference θ1b.

The processor 70 may calculate a phase difference based on received signals from the first to third antennas A1, A2, and A3 that are spaced apart from each other at different intervals and, thus, may accurately calculate position information of the external communication device 50b, in particular, angle information θ.

The processor 70 may control the first antenna A1 to output a transmit signal S2 based on the first received signal.

The antenna T1 of the external communication device 50b may receive the transmit signal S2 and may transmit a transmit signal S3 corresponding to the transmit signal S2.

As shown in FIG. 12, the first antenna A1, the second antenna A2, and the third antenna A3 may each receive the transmit signal S3 from the antenna T1 of the external communication device 50b. In this case, the signals received by the first antenna A1, the second antenna A2, and the third antenna A3 may be referred to as a fourth received signal, a fifth received signal, and a sixth received signal, respectively.

The processor 70 may calculate a third phase difference θ2a based on a difference between a fourth received signal received by the first antenna A1 and a fifth received signal received by the second antenna A2, may calculate a fourth phase difference θ2b based on a difference between the fourth received signal received by the first antenna A1 and a sixth received signal received by the third antenna A3, and may calculate position information of the external communication device 50b based on the third phase difference θ2a and the fourth phase difference θ2b.

That is, the processor 70 may repeatedly calculate a phase difference based on an additional transmit signal to more accurately calculate position information of the external communication device 50b.

The processor 70 may calculate distance information 1 of the external communication device 50b based on a time difference between the fourth received signal received by the first antenna A1 and the transmit signal S2, in response to the transmit signal S2.

The first to third antennas A1, A2, and A3 may be arranged in such a way that resolving power for estimating incident angles by the first and second antennas A1 and A2 is set to be less than an incident angle difference between an estimated solution of an incident angle by the first and third antennas A1 and A3 and an equivalent solution thereof in consideration of the aforementioned noise and resolving power.

The transmit signal S1, the transmit signal S2, and the transmit signal S3 of FIG. 12 may be a Blink signal, a response signal, and a final signal, respectively.

The Blink signal, the response signal, and the final signal may be a pairing signal or an interface signal after pairing.

When a structure of the communication device 50a of FIG. 11 is used, the first to third transceivers 30a, 30b, and 30c that access the first to third antennas A1, A2, and A3, respectively may be required.

The number of the first to third antennas A1, A2, and A3 may be reduced compared with the number of antennas. Hereinafter, an example of a method of reducing the number of antennas may be reduced using a switch is described.

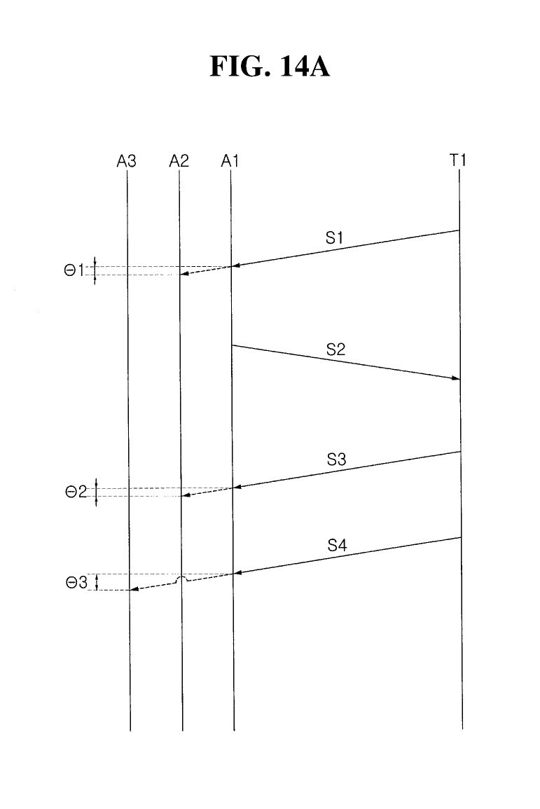

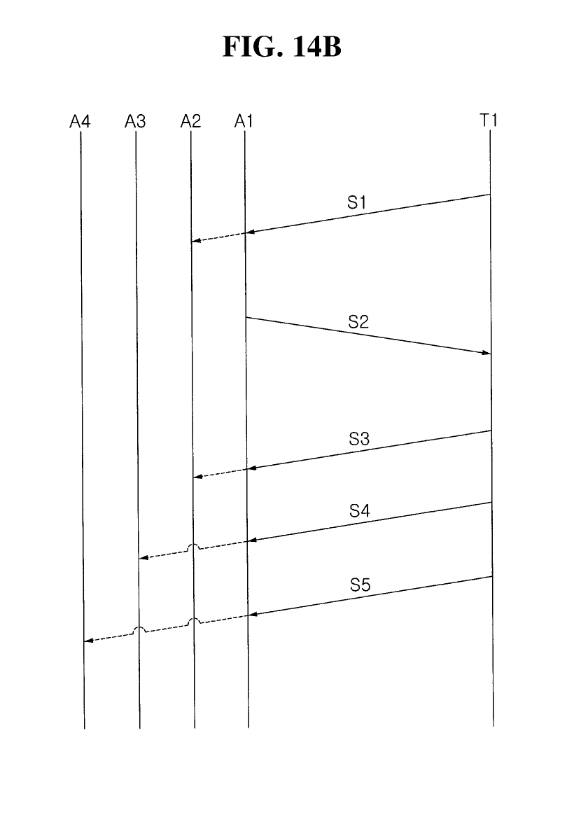

FIGS. 13A to 13C are internal block diagrams of an example of a communication device according to another embodiment of the present invention. FIGS. 14A and 14B are diagrams for explanation of an operation of the communication device of FIGS. 13A to 13C.

First, referring to FIG. 13A, a communication device 50aa according to another embodiment of the present invention may include the first to third antennas A1, A2, and A3 that are spaced apart from each other by different distances, the first transceiver 30a connected to the first antenna A1, a switch 45 connected to the second antenna A2 and the third antenna A3 and to perform a switching operation, the second transceiver 30b connected to the switch 45, and the processor 70 for controlling the first and second transceivers and the switch 45.

With reference to FIG. 14A, an operation of a communication device 50ab of FIG. 13A is described below.

As shown in FIG. 14A, in a state in which the second antenna A2 is switched on by the switch 45, the first antenna A1 and the second antenna A2 may each receive the transmit signal S1 from the antenna T1 of the external communication device 50b. In this case, the signals received by the first antenna A1 and the second antenna A2 may be referred to as a first received signal and a second received signal, respectively.

The processor 70 may calculate a first phase difference θ1 based on a difference between a first received signal received by the first antenna A1 and a second received signal received by the second antenna A2.

The processor 70 may control the first antenna A1 to output the transmit signal S2 based on the first received signal.

The antenna T1 of the external communication device 50b may receive the transmit signal S2 and may transmit the transmit signal S3 corresponding to the transmit signal S2.

In a state in which the second antenna A2 is switched on by the switch 45, the first antenna A1 and the second antenna A2 may each receive the transmit signal S3 from the antenna T1 of the external communication device 50b.

The processor 70 may calculate a phase difference θ2 based on a difference between a received signal received by the first antenna A1 and a received signal received by the second antenna A2.

In a state in which the third antenna A3 is switched on by the switch 45, the first antenna A1 and the third antenna A3 may each receive a transmit signal S4 from the antenna T1 of the external communication device 50b. In this case, the signals received by the first antenna A1 and the third antenna A3 may be referred to as a third received signal and a fourth received signal, respectively.

The processor 70 may calculate a second phase difference θ3 based on a difference between a third received signal received by the first antenna A1 and a fourth received signal received by the third antenna A3.

The processor 70 may calculate position information of the external communication device 50b based on the calculated first phase difference θ1 and second phase difference θ3. In particular, the processor 70 may calculate angle information of the external communication device 50b.

For example, the processor 70 may approximately calculate an incident angle of a transmit signal, i.e., angle information of the external communication device 50b based on the calculated first phase difference θ1 and may more precisely calculate angle information of the external communication device 50b based on the calculated second phase difference θ3.

The processor 70 may calculate position information of the external communication device 50b based on the calculated phase difference θ2 and second phase difference θ3. In particular, the processor 70 may calculate angle information of the external communication device 50b.

The processor 70 may calculate position information of the external communication device 50b based on the calculated first phase difference θ1, the phase difference θ2, and the second phase difference θ3. In particular, the processor 70 may calculate angle information of the external communication device 50b.

The processor 70 may calculate the distance information 1 of the external communication device 50b based on a time difference between a received signal S3 received by the first antenna A1 and the transmit signal S2 in response to the transmit signal S2.

FIG. 13B illustrates an example of the communication device 50ab according to another embodiment of the present invention.

In terms of a difference from in FIG. 13A, the communication device 50ab of FIG. 13B may further include a fourth antenna A4, a fifth antenna A5, a second switch 45b connected to the fourth antenna A4 and the fifth antenna A5 to perform a switching operation, and a third transceiver 30c connected to the second switch 45b.

An operation of the second switch 45b, an operation of the third transceiver 30c, and an operation of the processor 70 may be similar to an operation of a switch 45a, an operation of the second transceiver 30b, and an operation of the processor 70 of FIGS. 13A to 14A.

FIG. 13C shows an example of a communication device 50ac according to another embodiment of the present invention.

In terms of a difference from in FIG. 13A, the communication device 50ac of FIG. 13C may further include the fourth antenna A4 and the fifth antenna A5 and the switch 45 may be connected to the second to fifth antennas A2 to A5.

The switch 45 may be connected to the second transceiver 30b.

For explanation of an operation of FIG. 13C, referring to FIG. 14B, an operation during reception of the signal S1, transmission of the signal S2, reception of the signal S3, and reception of the signal S4 may be the same as in FIG. 14A.

That is, in a state in which the second antenna A2 is switched on by the switch 45, the processor 70 may calculate a first phase difference based on a difference between a first received signal received by the first antenna A1 and a second received signal received by the second antenna A2 and may control the first antenna A1 to output a transmit signal based on the first received signal and, in a state in which the third antenna A3 is switched on by the switch 45, the processor 70 may calculate a first phase difference based on a third received signal received by the first antenna A1 and a fourth received signal received by the third antenna A3 and may calculate position information of an external communication device based on the first phase difference and the second phase difference, in response to the transmit signal.

In particular, the processor 70 may calculate angle information of the position information of the external communication device based on the first phase difference and the second phase difference.

In a state in which the fourth antenna A4 is switched on by the switch 45, the first antenna A1 and the fourth antenna A4 may each receive a transmit signal S5 from the antenna T1 of the external communication device 50b. In this case, the signals received by the first antenna A1 and the fourth antenna A4 may be referred to as a fifth received signal and a sixth received signal, respectively.

The processor 70 may calculate a third phase difference θ4 based on a difference between a fifth received signal received by the first antenna A1 and a sixth received signal received by the fourth antenna A4.

In addition, the processor may more accurately calculate position information of an external communication device based on the third phase difference θ4.

The processor 70 may calculate distance information of the external communication device based on a time difference between the third received signal received by the first antenna A1 and the transmit signal, in response to the transmit signal.

The processor 70 may perform signal processing on a received signal with a highest level among a plurality of received signals received by the first antenna A1.

A distance between the first antenna A1 and the second antenna A2 may correspond to 0.5 times (0.5λ) a wavelength of each received signal and a distance between the first antenna A1 and the third antenna A3 may correspond to 1.5 times to 3 times (1.5λ to 3λ) a wavelength of each received signal.

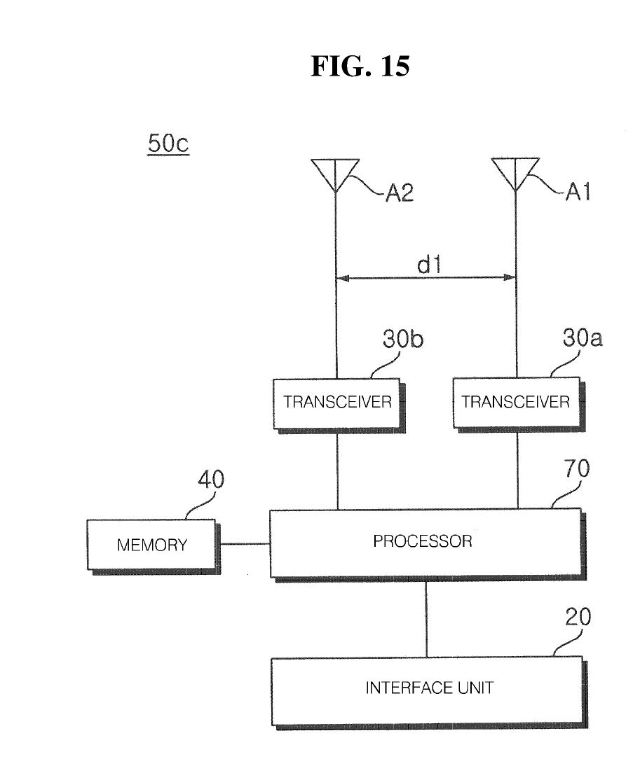

FIG. 15 is an internal block diagram of an example of a communication device according to another embodiment of the present invention.

Referring to the drawing, a communication device 50c according to another embodiment of the present invention may include first and second antennas A1 and A2 that are spaced apart from each other, first and second transceivers 30a and 30b connected to the first and second antennas A1 and A2, respectively, and the processor 70 for controlling the first and second transceivers 30a and 30b.

The communication device 50c may further include the memory 40 and the interface unit 20.

The first and second transceivers 30a and 30b may output transmit signals to the first and second antennas A1 and A2 or may receive received signals from the first and second antennas A1 and A2, respectively.

The processor 70 may calculate a first phase difference based on a difference between a first-frequency first received signal received by the first antenna A1 and a first-frequency second received signal received by the second antenna A2, may calculate a second phase difference based on a difference between a second-frequency third received signal received by the first antenna A1 and a second-frequency fourth received signal received by the second antenna A2, and may calculate position information of an external communication device based on the first phase difference and the second phase difference.

As such, when transmit signals with different frequencies are transmitted by the external communication device 50b, position information on the external communication device may be accurately calculated only two antennas but not three antennas.

In particular, the processor 70 may calculate angle information of the position information of the external communication device based on the first phase difference and the second phase difference.

The processor 70 may control the first antenna A1 to output a transmit signal based on the first received signal and may calculate distance information of an external communication device base on a time difference between a first-frequency fifth received signal received by the first antenna A1 and the transmit signal, in response to the transmit signal.

The processor 70 may calculate a third phase difference based on a difference between a first-frequency fifth received signal received by the first antenna A1 and a first-frequency sixth received signal received by the second antenna A2 and may further calculate position information of the external communication device based on the third phase difference, in response to the transmit signal.

The processor 70 may perform signal processing on a received signal with a highest level among a plurality of received signals received by the first antenna A1. In addition, signals received from other electronic devices may be disregarded and, accordingly, any one of a plurality of electronic devices may be capable of being paired or wirelessly connected.

The signals S1 to S5 or the like may be a pairing request signal for pairing or a pairing response signal. Alternatively, the signals S1 to S5 or the like may be a beacon signal or the like.

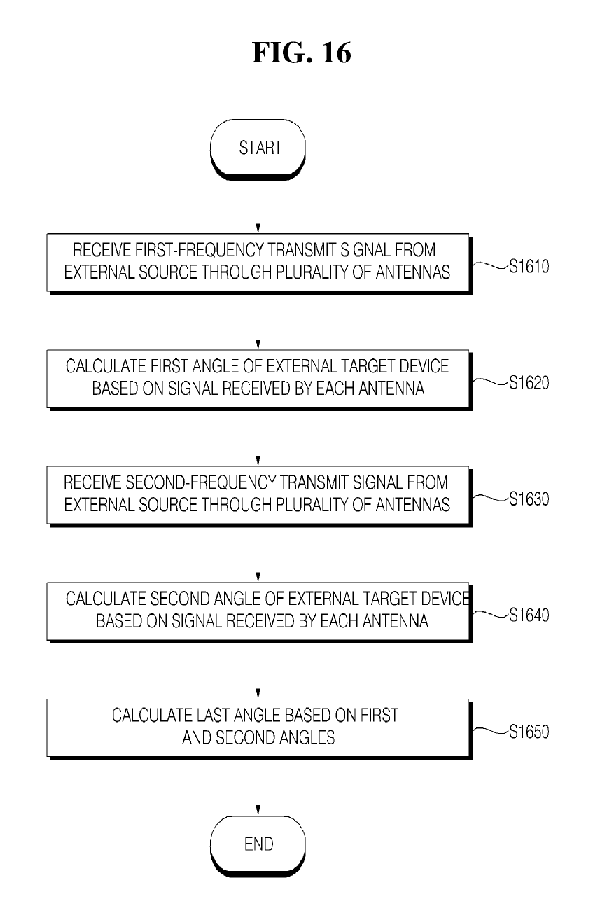

FIG. 16 is a flowchart for explanation of an operation of the communication device of FIG. 15.

Referring to the drawing, the processor 70 may receive a first-frequency transmit signal from an external source through a plurality of antennas (S1610).

Then, the processor 70 may calculate a first angle of an external electronic device based on a signal received by each antenna (S1620).

Then, the processor 70 may receive a second-frequency transmit signal from an external source through a plurality of antennas (S1630).

Then, the processor 70 may calculate a second angle of the external electronic device based on a signal received by each antenna (S1640).

Then, the processor 70 may calculate a last angle of the external electronic device based on the calculated first angle information and second angle information (S1650). Accordingly, the position information of the external communication device may be accurately calculated.

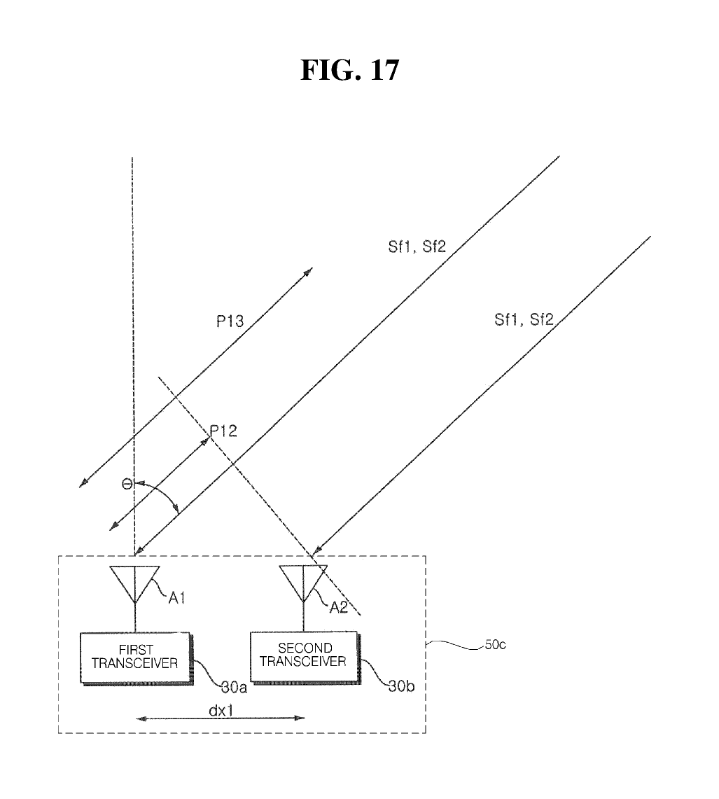

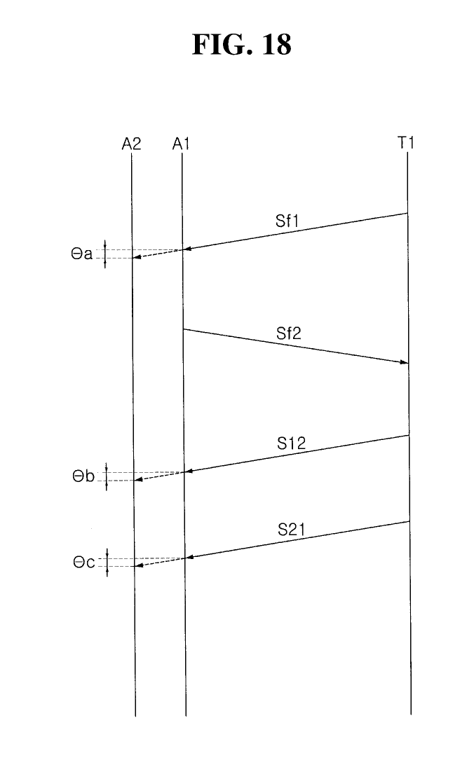

FIGS. 17 and 18 are diagrams for explanation of an operation of the communication device of FIG. 15 or 16.

FIG. 17 is a diagram showing an example of the case in which the first antenna A1 and the second antenna A2 are spaced apart from each other by a distance dx1.

The first antenna A1 may receive a first-frequency first received signal and a second-frequency third received signal

The second antenna A2 may receive a first-frequency second received signal and a second-frequency fourth received signal.

Referring to FIG. 18, the first antenna A1 and the second antenna A2 may each receive a first-frequency transmit signal Sf1 from the antenna T1 of the external communication device 50b. In this case, the signals received by the first antenna A1 and the second antenna A2 may be referred to as a first-frequency first received signal and a first-frequency second received signal, respectively.

The processor 70 may calculate a first phase difference θa based on a difference between a first-frequency first received signal received by the first antenna A1 and a first-frequency second received signal received by the second antenna A2.

The processor 70 may control the first antenna A1 to output a transmit signal Sf2 based on the first-frequency first received signal.

The transmit signal Sf2 may include frequency information to be changed, or the like.

The antenna T1 of the external communication device 50b may receive the transmit signal Sf2 and may transmit a second-frequency transmit signal Sf3 corresponding to the transmit signal Sf2.

The first antenna A1 and the second antenna A2 may each receive the transmit signal Sf3 from the antenna T1 of the external communication device 50b.

The processor 70 may calculate a phase difference θb based on a second-frequency third received signal received by the first antenna A1 and a second-frequency fourth received signal received by the second antenna A2.

The processor 70 may calculate position information of the external communication device 50b based on the calculated first phase difference θa and second phase difference θb. In particular, the processor 70 may calculate angle information of the external communication device 50b.

For example, the processor 70 may approximately calculate an incident angle of a transmit signal, i.e., angle information of the external communication device 50b based on the calculated first phase difference θa and may more accurately calculate angle information of the external communication device 50b based on the calculated second phase difference θb.

After receiving the transmit signal Sf3, the first antenna A1 and the second antenna A2 may further each receive a transmit signal Sf4 from the antenna T1 of the external communication device 50b.

The processor 70 may calculate a third phase difference θc based on a difference between a second-frequency fifth received signal received by the first antenna A1 and a second-frequency sixth received signal received by the second antenna A2.

The processor 70 may further calculate position information of the external communication device 50b based on the calculated third phase difference θc. In particular, the processor 70 may calculate angle information of the external communication device 50b. Accordingly, angle information of the external communication device 50b may be more accurately calculated.

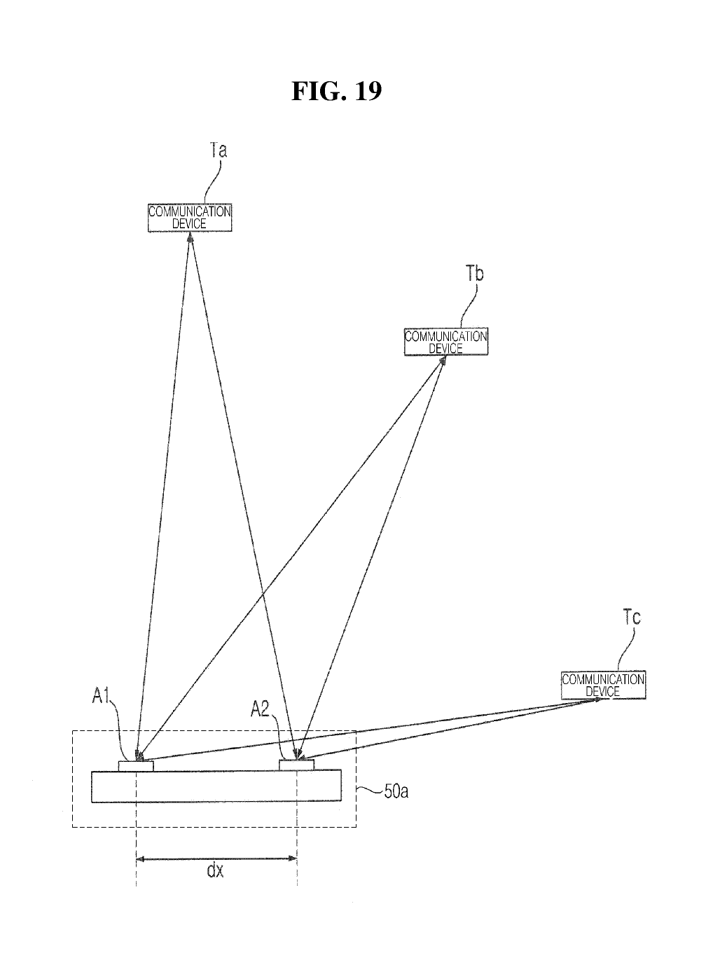

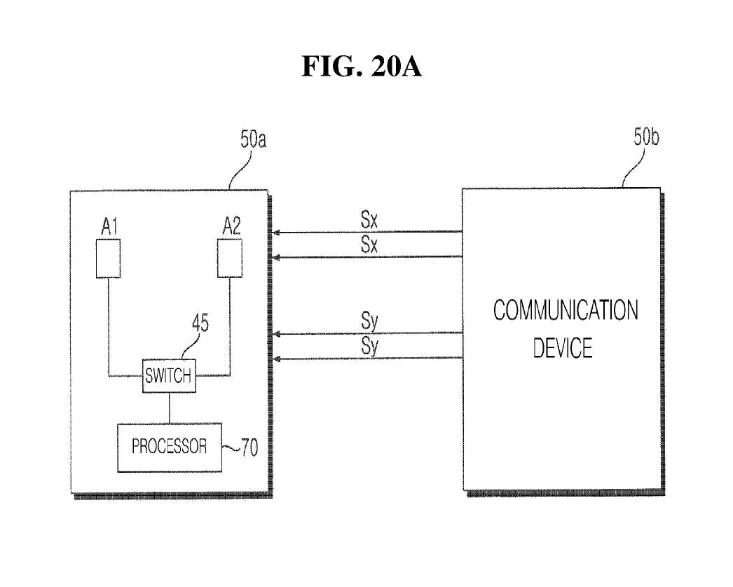

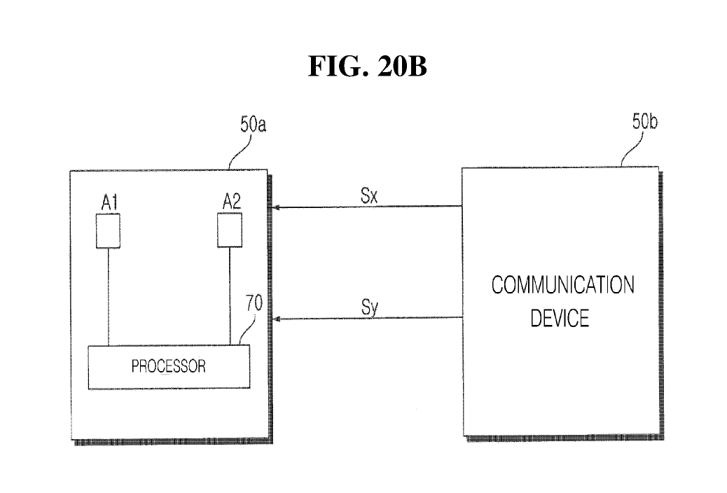

FIGS. 19 to 20B are diagrams for explanation of an operation of a communication device according to the present invention.

FIG. 19 is a diagram showing an example of the case in which signals from a plurality of communication devices ta, Tb, and Tc are received by the communication device 50a.

Although the drawing illustrates the case in which the communication device 50a includes only the first and second antennas A1 and A2, the present invention is not limited thereto, and three or more antennas may be arranged to be spaced apart from each other at different intervals.

The processor 70 of the communication device 50a may perform signal processing on a received signal with a highest level among a plurality of received signals received by the first antenna A1.

For example, the processor 70 in the communication device 50a may be configured in such a way that, when distances between a plurality of communication devices ta, Tb, and Tc shown in FIG. 19 and the communication device 50a are similar, as the calculated angle is reduced, a communication device and another communication device may face each other and a level of a received signal may be increased, as described above.

Accordingly, the processor 70 in the communication device 50a may perform signal processing a received signal with a highest level among a plurality of received signals received by the first antenna A1.

The processor 70 of the communication device 50a may calculate an angle of a plurality of communication devices, received by the first antenna A1, may select a communication device with a smallest calculated angle, and may perform control to signal-process only a received signal from the selected communication device.

The processor 70 in the communication device 50a may calculate angles of a plurality of communication devices, received by the first antenna A1, and may perform control to access a communication device with a smallest angle among the calculated angles via pairing therewith.

FIG. 20A is a diagram showing an example of the case in which signal reception Sx and Sy, etc. through the first antenna A1 and the second antenna A2 are repeatedly performed twice when a communication device 20a includes the switch 45.

FIG. 20B is a diagram showing an example of the case in which signal reception Sx and Sy, etc. through the first antenna A1 and the second antenna A2 are performed once when the communication device 20a does not include the switch 45.

Through such signal reception or the like, the processor 70 in the communication device 50a may accurately calculate position information (angle information and distance information) of the external communication device 50b, as described above.

The communication device and an operation method of an electronic device including the same may be implemented as processor-readable code stored in a processor-readable recording medium included in a network device. The processor-readable recording medium includes all kinds of recording media storing data readable by a processor. Examples of the processor-readable recording medium include a ROM, a RAM, a CD-ROM, a magnetic tape, a floppy disk, an optical data storage device and the like, and implementation as carrier waves such as transmission over the Internet. In addition, the processor-readable recording medium may be distributed to computer systems connected through a network, stored and executed as code readable in a distributed manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A communication device comprising:
first to third antennas spaced apart from each other by different distances;
first to third transceivers connected to the first to third antennas and to output transmit signals to the first to third antennas, respectively, or to receive received signals from the first to third antennas, respectively; and
a processor to control the first to third transceivers,
wherein the processor calculates a first phase difference based on a difference between a first received signal received by the first antenna and a second received signal received by the second antenna, calculates a second phase difference based on a difference between the first received signal received by the first antenna and a third received signal received by the third antenna, and calculates position information of an external communication device based on the first phase difference and the second phase difference.

2. The communication device according to claim 1, wherein the processor calculates angle information of the position information of the external communication device based on the first phase difference and the second phase difference.

3. The communication device according to claim 2, wherein the processor controls the first antenna to output a transmit signal based on the first received signal and calculates distance information of the external communication device based on a time difference between a fourth received signal received by the first antenna and the transmit signal in response to the transmit signal.

4. The communication device according to claim 3, wherein the processor calculates a third phase difference based on a difference between the fourth received signal received by the first antenna and a fifth received signal received by the second antenna, calculates a fourth phase difference based on a difference between the fourth received signal received by the first antenna and a sixth received signal received by the third antenna, and calculates the position information of the external communication device based on the third phase difference and the fourth phase difference, in response to the transmit signal.

5. The communication device according to claim 1, wherein the processor performs signal processing on a received signal with a highest level among a plurality of received signals received by the first antenna.

6. The communication device according to claim 1, wherein a distance between the first and second antennas corresponds to 0.5 times a wavelength of each received signal; and
wherein a distance between the first and third antennas corresponds to 1.5 to 3 times a wavelength of each received signal.

7. A communication device comprising:
first to third antennas spaced apart from each other by different distances;
a first transceiver connected to the first antenna;
a switch connected to second and third antennas and to perform a switching operation;
a second transceiver connected to the switch; and
a processor to control the first and second transceivers and the switch,
wherein, in a state in which the second antenna is switched on by the switch, the processor calculates a first phase difference based on a difference between a first received signal received by the first antenna and a second received signal received by the second antenna and controls the first antenna to output a transmit signal based on the first received signal and, in a state in which the third antenna is switched on by the switch, the processor calculates a first phase difference based on a third received signal received by the first antenna and a fourth received signal received by the third antenna and calculates position information of an external communication device based on the first phase difference and the second phase difference, in response to the transmit signal.

8. The communication device according to claim 7, wherein the processor calculates angle information of the position information of the external communication device based on the first phase difference and the second phase difference.

9. The communication device according to claim 8, wherein the processor calculates distance information of the external communication device based on a time difference between the third received signal received by the first antenna and the transmit signal, in response to the transmit signal.

10. The communication device according to claim 7, wherein the processor performs signal processing on a received signal with a highest level among a plurality of received signals received by the first antenna.

11. The communication device according to claim 7, wherein a distance between the first and second antennas corresponds to 0.5 times a wavelength of each received signal; and
wherein a distance between the first and third antennas corresponds to 1.5 to 3 times a wavelength of each received signal.

12. A communication device comprising:
first and second antennas spaced apart from each other;
first and second transceivers connected to the first and second antennas and to output transmit signals to the first and second antennas, respectively, or to receive received signals from the first and second antennas, respectively; and
a processor to control the first and second transceivers,
wherein the processor calculates a first phase difference based on a difference between a first-frequency first received signal received by the first antenna and a first-frequency second received signal received by the second antenna, calculates a second phase difference based on a difference between a second-frequency third received signal received by the first antenna and a second-frequency fourth received signal received by the second antenna, and calculates position information of an external communication device based on the first phase difference and the second phase difference.

13. The communication device according to claim 12, wherein the processor calculates angle information of the position information of the external communication device based on the first phase difference and the second phase difference.

14. The communication device according to claim 13, wherein the processor controls the first antenna to output a transmit signal based on the first received signal and calculates distance information of the external communication device based on a time difference between a first-frequency fifth received signal received by the first antenna and the transmit signal, in response to the transmit signal.

15. The communication device according to claim 12, wherein the processor calculates a third phase difference based on a difference between the first-frequency fifth received signal received by the first antenna and a first-frequency sixth received signal received by the second antenna and further calculates the position information of the external communication device based on the calculated third phase difference, in response to the transmit signal.

16. The communication device according to claim 12, wherein the processor performs signal processing on a received signal with a highest level among a plurality of received signals received by the first antenna.

17. An electronic device comprising:
a communication the communication device; and
a processor to maintain to be connected to the external communication device, the position information of which is calculated,
wherein the communication device comprising:
first to third antennas spaced apart from each other by different distances;
first to third transceivers connected to the first to third antennas and to output transmit signals to the first to third antennas, respectively, or to receive received signals from the first to third antennas, respectively; and
a processor to control the first to third transceivers,
wherein the processor calculates a first phase difference based on a difference between a first received signal received by the first antenna and a second received signal received by the second antenna, calculates a second phase difference based on a difference between the first received signal received by the first antenna and a third received signal received by the third antenna, and calculates position information of an external communication device based on the first phase difference and the second phase difference.
